(19) United States
(12) Patent Application Publication
(10) Pub. No.: US 2016/0099017 A1
(43) Pub. Date: Apr. 7, 2016

(54) LAYERED SEGREGANT HEAT ASSISTED MAGNETIC RECORDING (HAMR) MEDIA

(71) Applicant: HGST NETHERLANDS B.V., Amsterdam (NL)

(72) Inventors: Olav Hellwig, San Jose, CA (US); Oleksandr Mosendz, San Jose, CA (US); Dieter K. Weller, San Jose, CA (US)

(73) Assignee: HGST NETHERLANDS B.V., Amsterdam (NL)

(21) Appl. No.: 14/505,440

(22) Filed: Oct. 2, 2014

(51) Int. Cl. G11B 5/716; G11B 5/702

(52) U.S. Cl. CPC G11B 5/716; G11B 5/702; G11B 2005/0021

(57) ABSTRACT

According to one embodiment, a magnetic recording medium includes a substrate, and a magnetic recording layer structure positioned above the substrate, the magnetic recording layer structure including: a first magnetic recording layer having a first plurality of magnetic grains surrounded by a first segregant; a second magnetic recording layer positioned above the first magnetic recording layer, the second magnetic recording layer having a second plurality of magnetic grains surrounded by a second segregant; and a third magnetic recording layer positioned above the second magnetic recording layer, the third magnetic recording layer having a third plurality of magnetic grains surrounded by a third segregant, where at least the first segregant is primarily a combination of carbon and a second component, and where the second segregant is primarily carbon.

### FIELD OF THE INVENTION

The present invention relates to data storage systems, and more particularly, this invention relates to a layered segregant materials configured to improve magnetic grain shape in heat assisted magnetic recording (HAMR) media.

### BACKGROUND

The heart of a computer is a magnetic hard disk drive (HDD) which typically includes a rotating magnetic disk, a slider that has read and write heads, a suspension arm above the rotating disk and an actuator arm that swings the suspension arm to place the read and/or write heads over selected circular tracks on the rotating disk. The suspension arm biases the slider into contact with the surface of the disk when the disk is not rotating but, when the disk rotates, air is swirled by the rotating disk adjacent an air bearing surface (ABS) of the slider causing the slider to ride on an air bearing a slight distance from the surface of the rotating disk. When the slider rides on the air bearing the write and read heads are employed for writing magnetic impressions to and reading magnetic signal fields from the rotating disk. The read and write heads are connected to processing circuitry that operates according to a computer program to implement the writing and reading functions.

The volume of information processing in the information age is increasing rapidly. In particular, it is desired that HDDs be able to store more information in their limited area and volume. A technical approach to this desire is to increase the capacity by increasing the recording density of the HDD. To achieve higher recording density, further miniaturization of recording bits is effective, which in turn typically requires the design of smaller and smaller components.

However, the further miniaturization of the various components, particularly, the size and/or pitch of magnetic grains, presents its own set of challenges and obstacles in conventional products. Noise performance and spatial resolution are key parameters in magnetic recording media and are ongoing challenges to advance the achievable areal density of media. The dominant media noise source today is transition jitter. In sputtered media, it reflects the finite size, random positioning and dispersions in size, orientation and magnetic properties of the fine grains that comprise the media.

HAMR, also referred to as thermally assisted magnetic recording, has emerged as a promising magnetic recording technique to address grain size and transition jitter. As the coercivity of the ferromagnetic recording material is temperature dependent, HAMR employs heat to lower the effective coercivity of a localized region of the magnetic media and write data therein. The data state becomes stored, or “fixed,” upon cooling the magnetic media to ambient temperatures (i.e., normal operating temperatures typically in a range between about 15° C. and 60° C.). Heating the magnetic media may be accomplished by a number of techniques such as directing electromagnetic radiation (e.g. visible, infrared, ultraviolet light, etc.) onto the magnetic media surface via focused laser beams or near field optical sources. HAMR techniques may be applied to longitudinal and/or perpendicular recording systems, although the highest density storage systems are more likely to be perpendicular recording systems.

HAMR thus allows use of magnetic recording materials with substantially higher magnetic anisotropy and smaller thermally stable grains as compared to conventional magnetic recording techniques. Moreover, to further increase the areal density of magnetic recording media, granular magnetic recording materials may be utilized. Granular magnetic recording materials typically include a plurality of magnetic grains separated by one or more segregants, which aid in limiting the lateral exchange coupling between the magnetic grains. These segregants may influence magnetic properties, the size and shape of the magnetic grains, the exchange coupling strength between the magnetic grains, the grain boundary width, etc.

### SUMMARY

According to one embodiment, a magnetic recording medium includes a substrate, and a magnetic recording layer structure positioned above the substrate, the magnetic recording layer structure including: a first magnetic recording layer having a first plurality of magnetic grains surrounded by a first segregant; a second magnetic recording layer positioned above the first magnetic recording layer, the second magnetic recording layer having a second plurality of magnetic grains surrounded by a second segregant; and a third magnetic recording layer positioned above the second magnetic recording layer, the third magnetic recording layer having a third plurality of magnetic grains surrounded by a third segregant, where at least the first segregant is primarily a combination of carbon and a second component, and where the second segregant is primarily carbon.

According to another embodiment, a magnetic recording medium includes a substrate, and a magnetic recording layer structure positioned above the substrate, the magnetic recording layer structure including: a first magnetic recording layer having a first plurality of magnetic grains surrounded by a first segregant; a second magnetic recording layer positioned above the first magnetic recording layer, the second magnetic recording layer having a second plurality of magnetic grains surrounded by a second segregant; and a third magnetic recording layer positioned above the second magnetic recording layer, the third magnetic recording layer having a third plurality of magnetic grains surrounded by a third segregant, where the second segregant is different from the first segregant and/or the third segregant.

Any of these embodiments may be implemented in a magnetic data storage system such as a disk drive system, which may include a magnetic head, a drive mechanism for passing a magnetic medium (e.g., hard disk) over the magnetic head, and a controller electrically coupled to the magnetic head.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a simplified drawing of a magnetic recording disk drive system, according to one embodiment.

FIG. 2A is a cross-sectional view of a perpendicular magnetic head with helical coils, according to one embodiment.

FIG. 2B is a cross-sectional view a piggyback magnetic head with helical coils, according to one embodiment.

FIG. 3A is a cross-sectional view of a perpendicular magnetic head with looped coils, according to one embodiment.

FIG. 3B is a cross-sectional view of a piggyback magnetic head with looped coils, according to one embodiment.

FIG. 4A is a schematic representation of a section of a longitudinal recording medium, according to one embodiment.

FIG. 4B is a schematic representation of a magnetic recording head and the longitudinal recording medium of FIG. 4 A, according to one embodiment.

FIG. 5A is a schematic representation of a perpendicular recording medium, according to one embodiment.

FIG. 5B is a schematic representation of a recording head and the perpendicular recording medium of FIG. 5A, according to one embodiment.

FIG. 6A is a transmission electron microscopy (TEM) image of a granular FePtAg-C (35 at %) film.

FIG. 6B is a histogram of the magnetic grain size distribution present in a granular L1₀ FePtAg-C (35 at %) film.

FIG. 6C is a cross-sectional view of a TEM image showing the spherical magnetic grain shapes in a L1₀ FePtAg-C (35 at %) film.

FIG. 7 is a schematic representation of a simplified magnetic recording medium including a magnetic recording bilayer structure, according to one embodiment.

FIGS. 8A and 8B are cross sectional and top down views, respectively, of a

TEM image of a FePt-C/FePt-C magnetic recording bilayer structure.

FIGS. 9A and 9B are cross sectional and top down views, respectively, of a TEM image of a FePt-C+BN/FePt-C+BN magnetic recording bilayer structure.

FIGS. 10A and 10B are cross sectional and top down views, respectively, of a TEM image of FePt-C+BN/FePt-C magnetic recording bilayer structure.

FIGS. 11A and 11B are cross sectional and top down views, respectively, of a TEM image of a FePt-C/FePt-C+BN magnetic recording bilayer structure.

FIG. 12 is a schematic diagram of a simplified magnetic recording medium including a magnetic recording multilayer structure, according to one embodiment.

FIG. 13A is a cross sectional view of a TEM image of a FePt-C+BN/FePt-C/FePt-C+BN magnetic recording trilayer structure.

FIG. 13B is a close-up view of the TEM image shown in FIG. 13A.

FIG. 13C is a top down (areal) view of a TEM image of the FePt-C+BN/FePt-C/FePt-C+BN magnetic recording trilayer structure.

FIG. 13D is a plot of a hysteresis curve for a FePt-C+BN/FePt-C/FePt-C+BN magnetic recording tri layer structure.

FIG. 14 is a schematic diagram of the simplified magnetic recording medium of FIG. 12 including at least three magnetic recording layers, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, ail terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm.

The following description discloses several preferred embodiments of magnetic recording storage systems and/or related systems and methods, as well as operation and/or component parts thereof. For example, various embodiments disclosed herein include magnetic recording media having multilayered magnetic recording layers with different segregant materials. In particular approaches, the magnetic recording layers disclosed herein may include at least three magnetic layers, each having a carbon based segregant. Material components may be introduced to these carbon based segregates thereby improving the grain shape in addition to the magnetic properties of the magnetic medium.

In one general embodiment, a magnetic recording medium includes a substrate, and a magnetic recording layer structure positioned above the substrate, the magnetic recording layer structure including: a first magnetic recording layer having a first plurality of magnetic grains surrounded by a first segregant; a second magnetic recording layer positioned above the first magnetic recording layer, the second magnetic recording layer having a second plurality of magnetic grains surrounded by a second segregant; and a third magnetic recording layer positioned above the second magnetic recording layer, the third magnetic recording layer having a third plurality of magnetic grains surrounded by a third segregant, where at least the first segregant is primarily a combination of carbon and a second component, and where the second segregant is primarily carbon.

In another general embodiment, a magnetic recording medium includes a substrate, and a magnetic recording layer structure positioned above the substrate, the magnetic recording layer structure including: a first magnetic recording layer having a first plurality of magnetic grains surrounded by a first segregant; a second magnetic recording layer positioned above the first magnetic recording layer, the second magnetic recording layer having a second plurality of magnetic grains surrounded by a second segregant; and a third magnetic recording layer positioned above the second magnetic recording layer, the third magnetic recording layer having a third plurality of magnetic grains surrounded by a third segregant, where the second segregant is different from the first segregant and/or the third segregant.

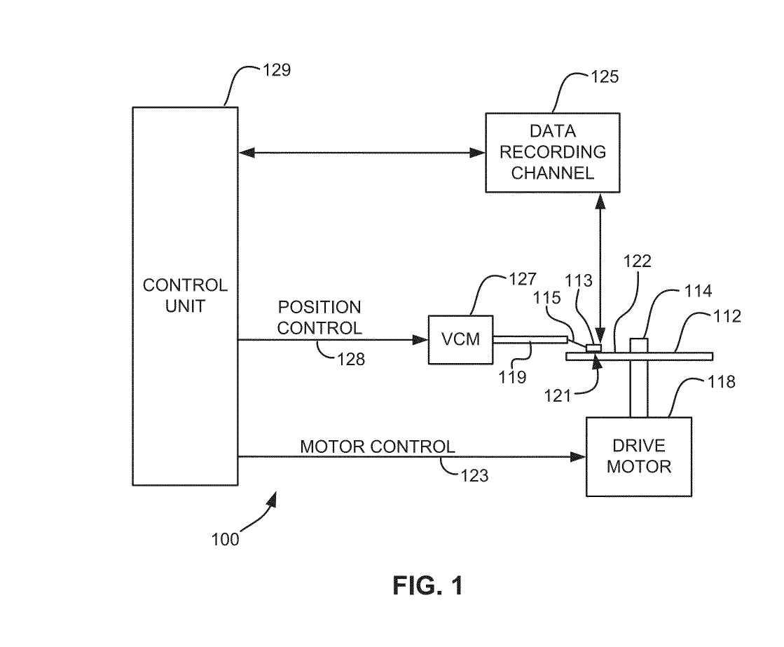

Referring now to FIG. 1, a disk drive 100 is shown in accordance with one embodiment. As an option, the disk drive 100 may be implemented in conjunction with features from any other embodiment listed herein, such as those described with reference to the other Figures. Of course, the disk drive 100 and others presented herein may be used in various applications and/or in permutations which may or may not be specifically described in the illustrative embodiments listed herein.

As shown in FIG. 1, at least one rotatable magnetic medium (e.g., magnetic disk) 112 is supported on a spindle 114 and rotated by a drive mechanism, which may include a disk drive motor 118. The magnetic recording on each disk is typically in the form of an annular pattern of concentric data tracks (not shown) on the disk 112. Thus, the disk drive motor 118 preferably passes the magnetic disk 112 over the magnetic read/write portions 121, described immediately below.

At least one slider 113 is positioned near the disk 112, each slider 113 supporting one or more magnetic read/write portions 121, e.g., of a magnetic head according to any of the approaches described and/or suggested herein. As the disk rotates, slider 113 is moved radially in and out over disk surface 122 so that portions 121 may access different tracks of the disk where desired data are recorded and/or to be written. Each slider 113 is attached to an actuator arm 119 by means of a suspension 115. The suspension 115 provides a slight spring force which biases slider 113 against the disk surface 122. Each actuator arm 119 is attached to an actuator 127. The actuator 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of disk 112 generates an air bearing between slider 113 and disk surface 122 which exerts an upward force or lift on the slider. The air bearing thus counter-balances the slight spring force of suspension 115 and supports slider 113 off and slightly above the disk surface by a small, substantially constant spacing during normal operation. Note that in some embodiments, the slider 113 may slide along the disk surface 122.

The various components of the disk storage system are controlled in operation by control signals generated by controller 129, such as access control signals and internal clock signals. Typically, control unit 129 comprises logic control circuits, storage (e.g., memory), and a microprocessor. In a preferred approach, the control unit 129 is electrically coupled (e.g., via wire, cable, line, etc.) to the one or more magnetic read/write portions 121, for controlling operation thereof. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Read and write signals are communicated to and from read/write portions 121 by way of recording channel 125.

The above description of a typical magnetic disk storage system, and the accompanying illustration of FIG. 1 is for representation purposes only. It should be apparent that disk storage systems may contain a large number of disks and actuators, and each actuator may support a number of sliders.

An interface may also be provided for communication between the disk drive and a host (integral or external) to send and receive the data and for controlling the operation of the disk drive and communicating the status of the disk drive to the host, all as will be understood by those of skill in the art.

In a typical head, an inductive write portion includes a coil layer embedded in one or more insulation layers (insulation stack), the insulation stack being located between first and second pole piece layers. A gap is formed between the first and second pole piece layers by a gap layer at an air bearing surface (ABS) of the write portion. The pole piece layers may be connected at a back gap. Currents are conducted through the coil layer, which produce magnetic fields in the pole pieces. The magnetic fields fringe across the gap at the ABS for the purpose of writing bits of magnetic field information in tracks on moving media, such as in circular tracks on a rotating magnetic disk.

The second pole piece layer has a pole tip portion which extends from the ABS to a flare point and a yoke portion which extends from the flare point to the back gap. The flare point is where the second pole piece begins to widen (flare) to form the yoke. The placement of the flare point directly affects the magnitude of the magnetic field produced to write information on the recording medium.

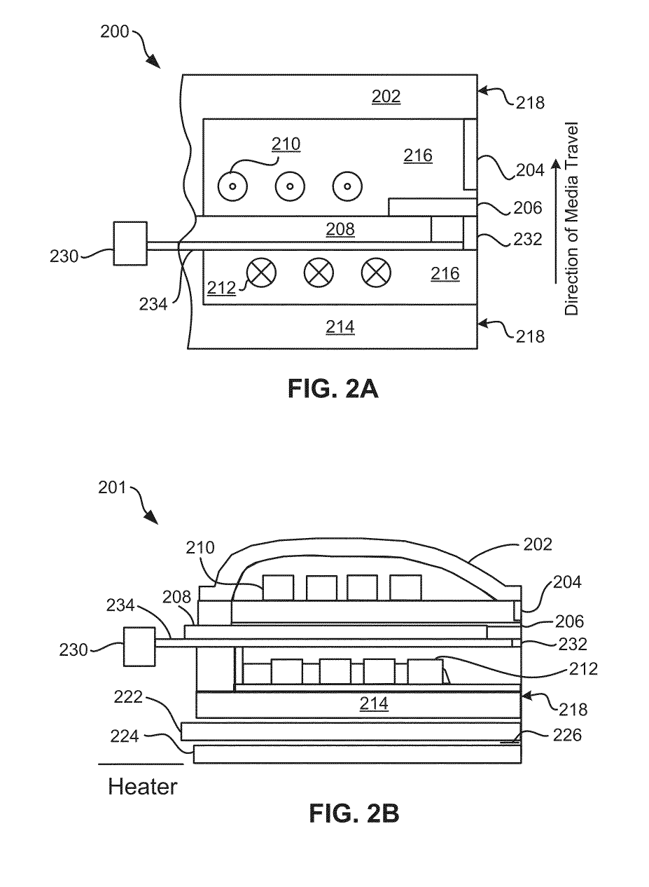

FIGS. 2A and 2B provide cross-sectional views of a magnetic head 200 and a piggyback magnetic head 201, according to various embodiments. As an option, the magnetic heads 200, 201 may be implemented in conjunction with features from any other embodiment listed herein, such as those described with reference to the other Figures. Of course, the magnetic heads 200, 201 and others presented herein may be used in various applications and/or in permutations which may or may not be specifically described in the illustrative embodiments listed herein.

As shown in the magnetic head 200 of FIG. 2A, helical coils 210 and 212 are used to create magnetic flux in the stitch pole 208, which then delivers that flux to the main pole 206. Coils 210 indicate coils extending out from the page, while coils 212 indicate coils extending into the page. Stitch pole 208 may be recessed from the ABS 218. Insulation 216 surrounds the coils and may provide support for some of the elements. The direction of the media travel, as indicated by the arrow to the right of the structure, moves the media past the lower return pole 214 first, then past the stitch pole 208, main pole 206, trailing shield 204 which may be connected to the wrap around shield (not shown), and finally past the upper return pole 202. Each of these components may have a portion in contact with the ABS 218. The ABS 218 is indicated across the right side of the structure.

Perpendicular writing is achieved by forcing flux through the stitch pole 208 into the main pole 206 and then to the surface of the disk positioned towards the ABS 218.

In various optional approaches, the magnetic head 200 may be configured for HAMR. Accordingly, for HAMR operation, the magnetic head 200 may include a heating mechanism of any known type to heat the magnetic medium (not shown). For instance, as shown in FIG. 2A according to one in one particular approach, the magnetic head 200 may include a light source 230 (e.g., a laser) that illuminates a near field transducer 232 of known type via a waveguide 234.

FIG. 2B illustrates one embodiment of a piggyback magnetic head 201 having similar features to the head 200 of FIG. 2A. As shown in FIG. 2B, two shields 204, 214 flank the stitch pole 208 and main pole 206. Also sensor shields 222, 224 are shown. The sensor 226 is typically positioned between the sensor shields 222, 224.

An optional heater is shown in FIG. 2B near the non-ABS side of the piggyback magnetic head 201. A heater (Heater) may also be included in the magnetic head 200 of FIG. 2A. The position of this heater may vary based on design parameters such as where the protrusion is desired, coefficients of thermal expansion of the surrounding layers, etc.

Moreover, in various optional approaches, the piggyback magnetic head 201 may also be configured for heat assisted magnetic recording (HAMR). Thus, for HAMR operation, the magnetic head 200 may additionally include a light source 230 (e.g., a laser) that illuminates a near field transducer 232 of known type via a waveguide 234.

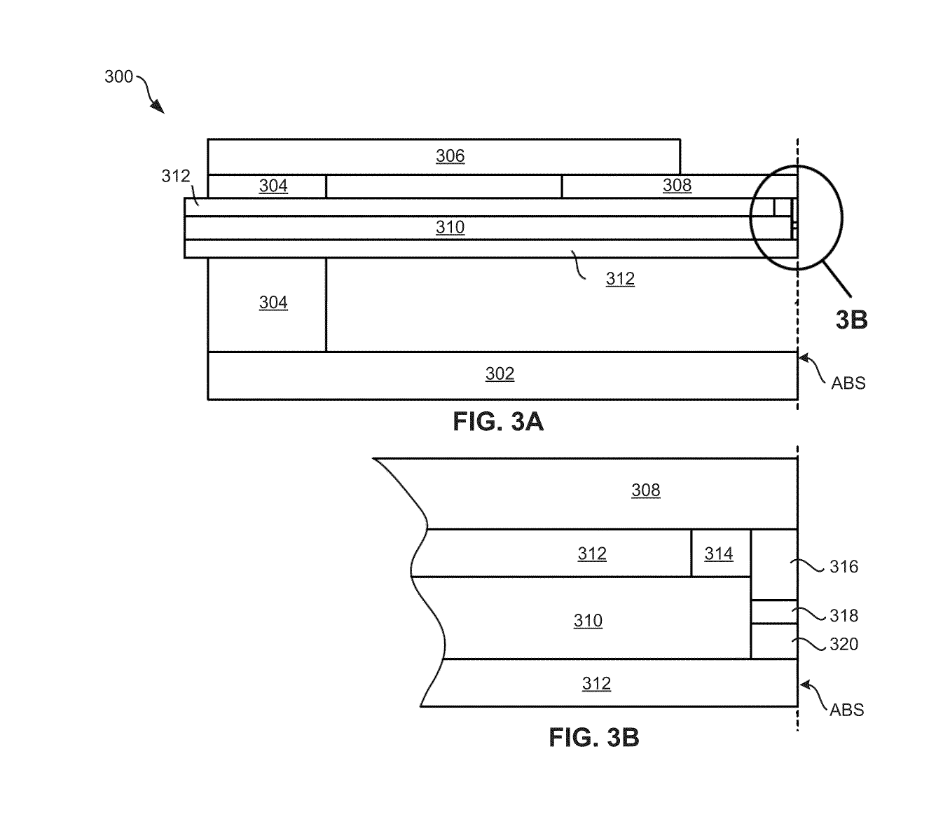

Referring now to FIG. 3A, a partial cross section view of a system 300 having a thin film perpendicular write head design incorporating an integrated aperture near field optical source (e.g., for HAMR operation) is shown according to one embodiment. As an option, this system 300 may be implemented in conjunction with features from any other embodiment listed herein, such as those described with reference to the other Figures. Of course, such a system 300 and others presented herein may be used in various applications and/or in permutations which may or may not be specifically described in the illustrative embodiments listed herein. Moreover, in order to simplify and clarify the general structure and configuration of the system 300, spacing layers, insulating layers, and write coil layers may be omitted from FIG. 3.

As shown in FIG. 3A, the write head has a lower return pole layer 302, back-gap layer(s) 304, upper return pole layer 306, and upper pole tip layer 308. In one approach, the lower return pole layer 302 may also have a lower pole tip (not shown) at the ABS. Layer 310 is an optical waveguide core, which may be used while conducting HAMR, e.g., to guide light from a light source to heat a medium (not shown) at the ABS when the system 300 is writing thereto. According to a preferred approach, the optical waveguide core is surrounded by cladding layers 312. Moreover, layers 310 and 312 may extend through at least a portion of back-gap layer(s) 304. The components inside of Circle 3B are shown in an expanded view in FIG. 3B, as discussed in further detail below.

Layer 310 may be comprised of a suitable light transmitting material, as would be known by one of reasonable skill in the relevant art. Exemplary materials include Ta₂O₅, and/or TiO₂. As shown, the core layer 310 has approximately uniform cross section along its length. As well known in the art, the optical waveguide can have a number of other possible designs including a planar solid immersion mirror or planar solid immersion lens which have a non-uniform core cross section along the waveguide's length.

In various approaches, coil layers (not shown) and various insulating and spacer layers (not shown) might reside in the cavity bounded by the ABS, back-gap(s) 304, lower return pole 302, and/or upper bounding layers 306, 308, and 312 as would be recognized by those of skill in the art. Layers 302, 304, 306, and 308 may be comprised of a suitable magnetic alloy or material, as would be known by one of reasonable skill in the relevant art. Exemplary materials include Co, Fe, Ni, Cr and combinations thereof.

As described above, FIG. 3B is a partial cross section expanded view of detail 3B in FIG. 3A, in accordance with one embodiment. Pole lip 316 is magnetically coupled to upper pole tip layer 308, and to optional magnetic step layer 314. Aperture 318 (also known as a ridge aperture), surrounding metal layer 320, and pole lip 316 comprise the near field aperture optical source (or near field transducer), which is supplied optical energy via optical waveguide core 310. Pole lip 316 and optional magnetic step layer 314 may be comprised of a suitable magnetic alloy, such as Co, Fe, Ni, Cr and/or combinations thereof. Metal layer 320 may be comprised of Cu, Au, Ag, and/or alloys thereof, etc.

With continued reference to FIG. 3B, cladding layer 312 thickness may be nominally about 300 nm, but may be thicker or thinner depending on the dimensions of other layers in the structure. Optional magnetic step layer 314 may have a nominal thickness (the dimension between layers 308 and 310) of about 300 nm, and a nominal depth (as measured from layer 316 to layer 312) of about 180 nm. Pole lip 316 may have a nominal depth (as measured from the ABS) approximately equal to that of layer 320, with the value being determined by the performance and properties of the near field optical source (see examples below). The thickness of the pole lip 316 can vary from about 150 nm (with the optional magnetic step layer 314) to about 1 micron, preferably between about 250 nm and about 350 nm. The thickness of optical waveguide core layer 310 may be nominally between about 200 nm and about 400 nm, sufficient to cover the thickness of the aperture 318. In the structure shown in FIG. 3B, the layer 308 extends to the ABS. In some preferred embodiments, the layer 308 may be recessed from the ABS while maintaining magnetic coupling with the layers 314 and 316.

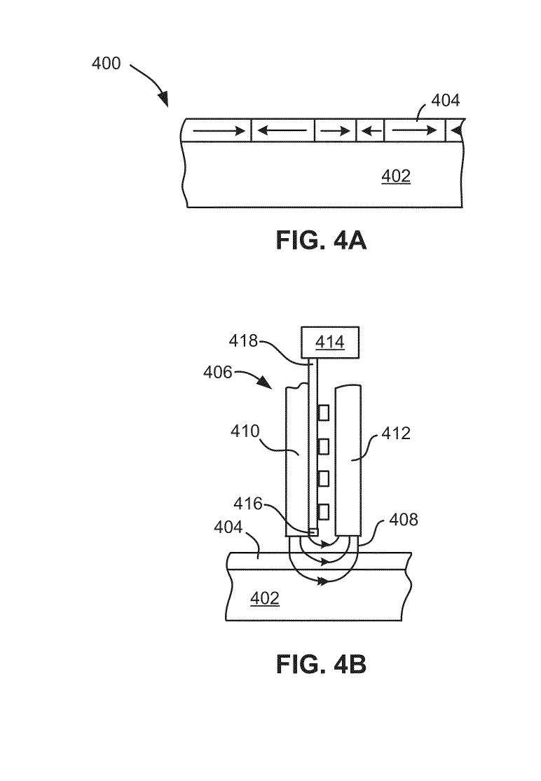

FIG. 4A provides a schematic illustration of a longitudinal recording medium 400 typically used with magnetic disc recording systems, such as that shown in FIG. 1. This longitudinal recording medium 400 is utilized for recording magnetic impulses in (or parallel to) the plane of the medium itself. This longitudinal recording medium 400, which may be a recording disc in various approaches, comprises at least a supporting substrate 402 of a suitable non-magnetic material such as glass, and a magnetic recording layer 404 positioned above the substrate.

FIG. 4B shows the operative relationship between a recording/playback head 406, which may preferably be a thin film head and/or other suitable head as would be recognized by one having skill in the art upon reading the present disclosure, and the longitudinal recording medium 400 of FIG. 4A. As shown in FIG. 4B, the magnetic flux 408, which extends between the main pole 410 and return pole 412 of the recording/playback head 406, loops into and out of the magnetic recording layer 404.

In various optional approaches, the recording/playback head 406 may additionally be configured for heat assisted magnetic recording (HAMR). Accordingly, for HAMR operation, the recording/playback head 406 may include a heating mechanism of any known type to heat, and thus lower the effective coercivity, of a localized region on the magnetic medium 400 surface in the vicinity of the main pole 410. For instance, as shown in FIG. 4B, a light source 414 such as a laser illuminates a near field transducer 416 of known type via a waveguide 418.

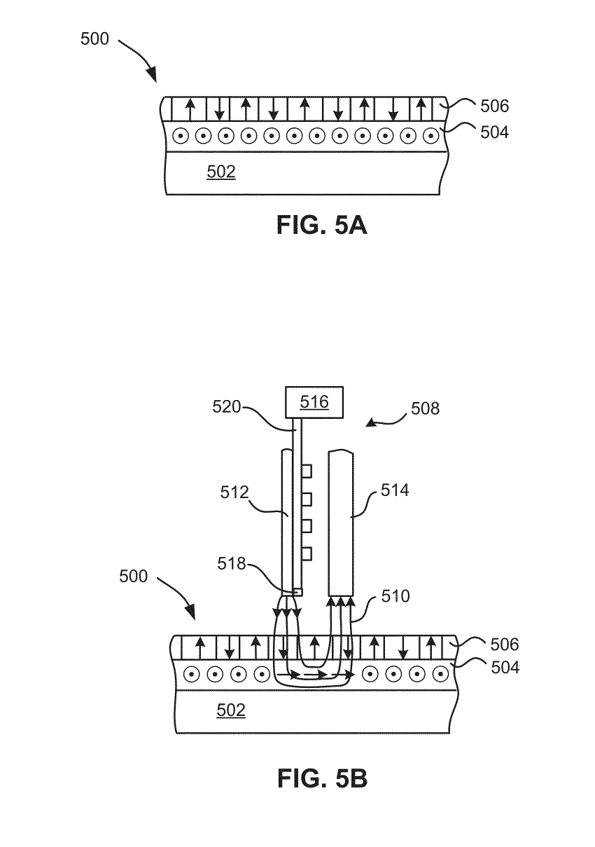

Improvements in longitudinal recording media have been limited due to issues associated with thermal stability and recording field strength. Accordingly, pursuant to the current push to increase the areal recording density of recording media, perpendicular recording media (PMR) has been developed and found to be superior to longitudinal recording media. FIG. 5A provides a schematic diagram of a simplified perpendicular recording medium 500, which may also be used with magnetic disc recording systems, such as that shown in FIG. 1. As shown in FIG. 5A, the perpendicular recording medium 500, which may be a recording disc in various approaches, comprises at least a supporting substrate 502 of a suitable non-magnetic material (e.g., glass, aluminum, etc.), and a soft magnetic underlayer 504 of a material having a high magnetic permeability positioned above the substrate 502. The perpendicular recording medium 500 also includes a magnetic recording layer 506 positioned above the soft magnetic underlayer 504, where the magnetic recording layer 506 preferably has a high coercivity relative to the soft magnetic underlayer 504. There may be several additional layers present, such as an “exchange-break” layer or “interlayer” (not shown) between the soft magnetic underlayer 504 and the magnetic recording layer 506.

The orientation of magnetic impulses in the magnetic recording layer 506 is substantially perpendicular to the surface of the recording layer. The magnetization of the soft magnetic underlayer 504 is oriented in (or parallel to) the plane of the soft magnetic underlayer 504. As particularly shown in FIG. 5A, the in-plane magnetization of the soft magnetic underlayer 504 may be represented by an arrow extending into the paper.

FIG. 5B illustrates the operative relationship between a perpendicular head 508 and the perpendicular recording medium 500 of in FIG. 5A. As shown in FIG. 5B, the magnetic flux 510, which extends between the main pole 512 and return pole 514 of the perpendicular head 508, loops into and out of the magnetic recording layer 506 and soft magnetic underlayer 504. The soft magnetic underlayer 504 helps focus the magnetic flux 510 from the perpendicular head 508 into the magnetic recording layer 506 in a direction generally perpendicular to the surface of the magnetic medium 500. Accordingly, the intense magnetic field generated between the perpendicular head 508 and the soft magnetic underlayer 504, enables information to be recorded in the magnetic recording layer 506. The magnetic flux is further channeled by the soft magnetic underlayer 504 back to the return pole 514 of the head 508.

As noted above, the magnetization of the soft magnetic underlayer 504 is oriented in (parallel to) the plane of the soft magnetic underlayer 504, and may represented by an arrow extending into the paper. However, as shown in FIG. 5B, this in plane magnetization of the soft magnetic underlayer 504 may rotate in regions that are exposed to the magnetic flux 510.

It should be again noted that in various approaches, the perpendicular head 508 may be configured for heat assisted magnetic recording (HAMR). Accordingly, for HAMR operation, the perpendicular head 508 may include a heating mechanism of any known type to heat, and thus lower the effective coercivity of, a localized region on the magnetic media surface in the vicinity of the main pole 518. For instance, as shown in FIG. 5B, a light source 516 such as a laser illuminates a near field transducer 518 of known type via a waveguide 520.

Except as otherwise described herein with reference to the various inventive embodiments, the various components of the structures of FIGS. 1-5B, and of other embodiments described herein, may be of conventional materials and design, and fabricated using conventional techniques, as would be understood by one skilled in the art upon reading the present disclosure.

As discussed previously, HAMR allows magnetic recording technology to use materials with substantially larger magnetic anisotropy (e.g., small thermally stable grains are possible) and coercive field by localized heating of the magnetic layer above its Curie temperature, where anisotropy is reduced. One example of a magnetic recording material having a particularly high magnetic anisotropic constant, and thus particularly suitable for HAMR purposes, is a chemically ordered L1₀ FePt alloy. A chemically-ordered L1₀ FePt alloy, in its bulk form, is known as a face-centered tetragonal (FCT) L1₀-ordered phase material (also called a CuAu material). The c-axis of the L1₀ phase is the easy axis of magnetization and is oriented perpendicular to the disk substrate.

Chemical ordering in a FePt alloy is achieved by deposition thereof at elevated temperatures (about 450 to about 700° C.). However elevated deposition temperature of a granular FePt magnetic recording layer may result in unwanted grain joining, coalescence and surface roughening and thus deteriorate the layer's microstructure and magnetic properties. One or more segregants may thus be added to a L1₀ FePt based magnetic recording layer to isolate the L1₀ FePt magnetic grains.

In one embodiment, a magnetic recording layer may include a plurality of L1₀ FePt magnetic grains surrounded, and thereby isolated, by a carbon segregant. The carbon segregant may be present in the magnetic recording layer in an amount ranging from about 20 at % to about 50 at %, in some approaches. However, formation of a L1₀ FePt-C magnetic recording layer via sputtering at about 600 to about 650° C. results in spherical L1₀ FePt magnetic grains, which may undesirably limit the thickness of the magnetic recording layer at an average grain diameter (e.g., in the range from about 6 nm to about 8 nm) and thus impose a serious limitation on the signal strength of said layer. Moreover, a L1₀ FePt-C magnetic recording layer may also be rough, having a bimodal L1₀ FePt magnetic grain size distribution comprised of larger grains (with grain diameters ranging from about 6 nm to about 8 nm) and thermally unstable smaller grains (with grain diameters less than about 3 nm).

Attempts to form cylindrical or columnar magnetic grains, which are particularly applicable to perpendicular magnetic recording purposes, may involve partially or completely replacing the aforementioned carbon segregant in a L1₀ FePt based magnetic recording layer with one or more oxides, according to another embodiment. Suitable oxides may include TiO₂, SiO₂AlO₂, Al₂O₃, MgO, Ta₂O₅, B₂O₃, or other oxide as would become apparent to one skilled in the art upon reading the present disclosure. In comparison to a L1₀ FePt-C magnetic recording layer, a L1₀ FePt-oxide magnetic recording layer may have reduced roughness and a more columnar magnetic grain shape. However, inclusion of one or more oxide segregants in a L1₀ FePt based magnetic recording layer may ultimately compromise (i.e., degrade) the magnetic properties of the layer. For instance, replacing a carbon segregant with one or more oxide segregants in a L1₀ FePt based magnetic recording layer may drop the coercivity, Hc, from values of up to about 5.2 Teslas does to values below about 0.1 Tesla. Without wishing to be bound by any particular theory, it is believed that this drop in coercivity may be due to the partial oxidation of the L1₀ FePt, and/or to the partial incorporation of portions of the oxide segregant into the L1₀ FePt magnetic grains.

In yet another embodiment aimed at forming cylindrical or columnar magnetic grains, the aforementioned carbon segregant in a L1₀ FePt based magnetic recording layer may be partially and/or completely replaced with one or more non-oxide segregants. Non-oxide segregants may include AlN, TaN, W, Ti, BN, SiNₓ, SiNₓ+C, or other suitable non-oxide segregants that become apparent to one having ordinary skill in the art upon reading the present disclosure. In one particular approach, a L1₀ FePt based magnetic recording layer may include a BN segregant. However, despite optimization of growth conditions (e.g., pressure, deposition temperature, growth rate, etc.), the thickness of the L1₀ FePt-BN magnetic recording layer is still limited. Moreover, the coercivity of the L1₀ FePt-BN magnetic recording layer may drop to values as low as about 1.5 Tesla, as compared to a L1₀ FePt-C magnetic recording layer with a coercivity around about 4.5 Tesla to about 5.2 Tesla. A coercivity of about 1.5 Tesla is better than the coercivity of about 0.1 Tesla or less achieved using an oxide segregant, yet still insufficient for good HAMR magnetic recording media. Accordingly, while a non-oxide segregant in a L1₀ FePt based magnetic recording layer may impart less of a spherical shape on the magnetic grains as compared to a carbon segregant, a non-oxide segregant may also undesirably degrade the magnetic properties of said magnetic recording layer.

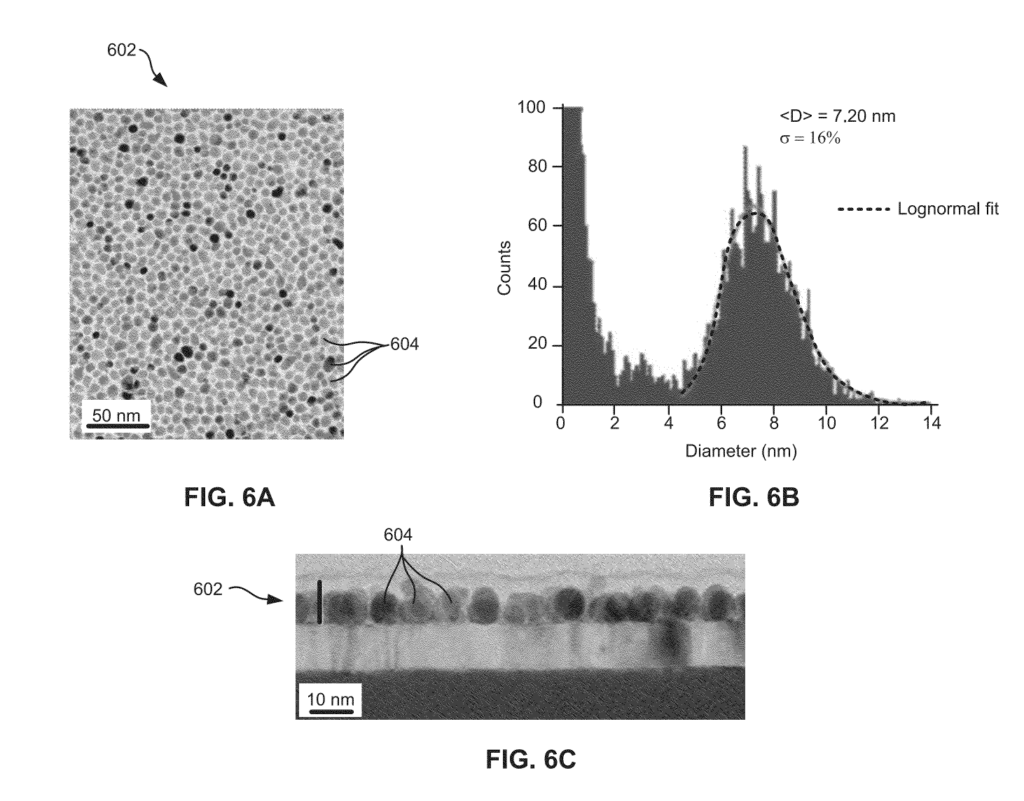

In other embodiments, a magnetic recording layer may include a L1₀ FePtX alloy surrounded by any of the aforementioned segregants (e.g., C, an oxide segregant, a non-oxide segregant etc.), where X is a material configured to optimize (e.g., reduce) the growth and/or Curie temperature associated with the magnetic recording layer. Suitable materials for X may include Ag, Cu, Au, Ni, Mn, Pd, and other materials that would become apparent to one skilled in the art upon reading the present disclosure. However, a magnetic recording layer including a L1₀ FePtX alloy with a carbon, oxide and/or non-oxide segregant may still exhibit unwanted magnetic grain size distributions, magnetic grain shapes and magnetic properties. For example, a sputtered 6 nm thick L1₀ FePtAg-C (35 at %) film produces spherical magnetic grains and bimodal distribution of magnetic grain sizes. FIG. 6A provides a transmission electron microscopy (TEM) image of such a granular film 602 including FePtAg-C (35 at %) magnetic grains 604. FIG. 6B provides a histogram of magnetic grain size distribution of the L1₀ FePtAg-C (35 at %) magnetic grains 604 present in this granular film 602, where the dotted line corresponds to a lognormal fit resulting in an average magnetic grain size of 7.20 nm and a small standard deviation of σ=16%. FIG. 6C provides a cross-sectional view of a TEM image showing the spherical shapes of the L1₀ FePtAg-C (35 at %) magnetic grains 604 in the granular film 602. Disadvantages associated with the L1₀ FePtAg-C (35 at %) film therefore include small, thermally unstable magnetic grains, which may reduce the remanent moment in the magnetic hysteresis loops.

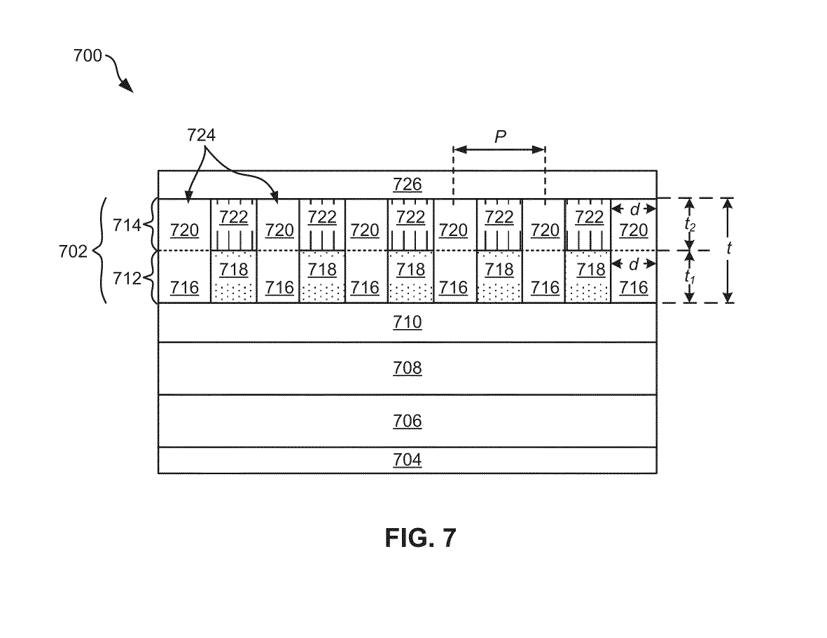

Referring now to FIG. 7, a magnetic recording medium 700 may include a magnetic recording bilayer structure 702, according to further embodiments. As an option, the magnetic recording medium 700 may be implemented in conjunction with features from any other embodiment listed herein, such as those described with reference to the other Figures. Of course, the magnetic recording medium 700, and others presented herein may be used in various applications and/or in permutations which may or may not be specifically described in the illustrative embodiments listed herein. For instance, various embodiments of the magnetic recording medium 700 may include more or less layers than those shown in FIG. 7. Moreover, unless otherwise specified, formation of one or more of the layers shown in FIG. 7 may be achieved via atomic layer deposition (ALD), chemical vapor deposition (CVD), evaporation, e-beam evaporation, ion beam deposition, sputtering, or other deposition technique as would become apparent to a skilled artisan upon reading the present disclosure. Further, the magnetic recording medium 700 and others presented herein may he used in any desired environment.

As shown in FIG. 7, the magnetic recording medium 700 includes a substrate layer 704 comprising a material of high rigidity, such as glass, Al, Al₂O₃, MgO, Si, or other suitable substrate material as would be understood by one having skill in the art. upon reading the present disclosure. In preferred approaches, the substrate layer 704 includes a material that allows media deposition at elevated temperatures, e.g., on the order of 600-800° C.

The magnetic recording medium 700 also includes an adhesion layer 706 positioned above the substrate layer 704. In various approaches, the adhesion layer 706 may comprise Ni, Ta, Ti, and/or alloys thereof. In preferred approaches, the adhesion layer may comprise an amorphous material that does not affect the crystal orientation of the layers deposited thereon.

The magnetic recording medium 700 additionally includes a heat dissipating (heat sink) layer 708 positioned above the adhesion layer 706. The heat sink layer 708, which may include a material having a high thermal conductivity (e.g., greater than 30 W/m-K, preferably greater than 100 W/m-K), may be particularly useful for HAMR purposes. For instance, the heat sink layer 708 is configured to allow heat deposited in one or more magnetic layers positioned thereabove to quickly dissipate and limits lateral heat flow in said magnetic layer(s), thus introducing directional vertical heat flow, which allows for a small heat spot and high thermal gradient during recording. In various approaches, this heat sink layer 708 may be a plasmonic layer. Suitable materials for the heat sink layer 708 may include, but are not limited to Ta, Ti, Cr, Fe, Cu, Ag, Pt, Au, Cr, Mo, etc. and alloys thereof.

The magnetic recording medium 700 further includes a seed layer 710 positioned above the heat sink layer 708. The seed layer 710 may act as a texture defining layer, e.g., configured to influence the epitaxial growth of the magnetic recording layers 712, 714 formed thereabove. In some approaches, the seed layer 710 may include MgO, TiN, MgTiOₓ, SrTiOₓ, TiC, MgFeOx etc. or suitable seed layer materials as would become apparent to one skilled in the art upon reading the present disclosure. In more approaches, the seed layer 710 may have a bilayer structure, e.g., with a lower CrRu layer and an upper Pt layer on the CrRu layer,

While not shown in FIG. 7, an optional soft magnetic underlayer may be positioned between the adhesion layer 706 and the seed layer 710, This soft magnetic underlayer may be configured to promote data recording in the magnetic recording layers 712, 714, Accordingly, in preferred approaches, this soft magnetic underlayer may include a material having a high magnetic permeability. Suitable materials for the soft magnetic underlayer may include, but are not limited to, Fe, FeNi, FeCo, a Fe-based alloy, a FeNi-based alloy, a FeCo-based alloy, Co-based ferromagnetic alloys, and combinations thereof. In some approaches, this soft magnetic underlayer may include a single layer structure or a multilayer structure. For instance, one example of a multilayer soft magnetic underlayer structure may include a coupling layer (e.g., including Ru) sandwiched between one or more soft magnetic underlayers, where the coupling layer is configured to induce an anti-ferromagnetic coupling between one or more soft magnetic underlayers. In some approaches, the soft magnetic underlayer may be a laminated or multilayered soft magnetic underlayer structure including multiple soft magnetic films separated by nonmagnetic films, such as electrically conductive films of Al or CoCr. In more approaches, the soft magnetic underlayer may also be a laminated or multilayered soft magnetic underlayer structure including multiple soft magnetic films separated by interlayer films that mediate an antiferromagnetic coupling, such as Ru, Ir, or Cr or alloys thereof.

It is important to note that in some approaches, the magnetic recording medium 700 may include the heat sink layer 708 and a soft magnetic underlayer, both of which may be positioned between the adhesion layer 706 and the seed layer 710. In approaches where both a soft magnetic underlayer and a heat sink layer 708 are present, the soft magnetic underlayer may be positioned above or below the heat sink layer 708, as equivalent effects may be provided regardless of the position of the soft magnetic underlayer relative to the heat sink layer 708.

As also shown in FIG. 7, the magnetic recording medium includes the magnetic recording bilayer structure 702 present above the seed layer 710. The magnetic recording bilayer structure 702 includes a first magnetic recording layer 712 and a second magnetic recording layer 714 positioned above the first magnetic recording layer 712. The first magnetic recording layer 712 includes a plurality of magnetic grains 716 separated by a first segregant 718. Similarly, the second magnetic recording layer 714 includes a plurality of magnetic grains 720 separated by a second segregant 722. In preferred approaches, the plurality of magnetic grains 716, 720 in the first and second magnetic recording layers 712, 714 may have a columnar shape.

The magnetic recording layers 712, 714 may be formed using a sputtering process. According to one approach, the magnetic grain material(s) and one or more segregant component(s) may be sputtered from the same target; however, in another approach, the magnetic grain material(s) and/or segregant components) may be sputtered from different, respective targets. The magnetic grain and segregant materials are preferably deposited onto the magnetic recording medium 700 at the same time, in a heated environment, e.g., from about 400 degrees to about 800° C. in approaches where at least one granular chemically ordered L1₀ FePt magnetic recording layer is desired.

To facilitate a conformal growth of the first and second magnetic recording layers 712, 714, an etching step is preferably (but not necessarily) performed on each of the respective magnetic layers after they are formed. Thus, an etching step may be used to define the upper surface of each of the magnetic layers and expose the material of the magnetic layer, e.g., before an additional layer is formed there above. According to various approaches, the etching step may include an Inductively Coupled Plasma (ICP) etch step, etc. or any other etching process that would become apparent to one skilled in the art upon reading the present disclosure.

Accordingly, the magnetic grains 720 of the second magnetic recording layer 714 may be physically characterized by growth directly on the magnetic grains 716 of the first magnetic recording layer 712, which may primarily be due to the etching step noted above. Thus, each of the magnetic grains 720 of the second magnetic recording layer 714 that are formed directly above the magnetic grains 716 of the first magnetic recording layer 712 may form a larger composite magnetic grain 724 that extends along the total thickness, t, of the magnetic recording bilayer structure 702.

In some approaches, the total thickness, t, of the magnetic recording bilayer structure 702 may be between about 2 nm to about 20 nm. In more approaches, each of the two magnetic recording layers 712, 714 may have a respective thickness t₁, t₂ from about 1 nm to about 10 nm, preferably about 6 nm. Moreover, the thicknesses t₁ and t₂ may be the same or different in various approaches.

In numerous approaches, an average pitch, P, (center-to-center spacing) of the magnetic grains 716, 720 in the first and/or second magnetic recording layers 712, 714 may be in a range from about 5 nm to about 11 nm, but could be higher or lower depending on the desired application. Furthermore, an average diameter, d, of the magnetic grains 716, 720 in the first and/or second magnetic recording layers 712, 714 may preferably be in a range from about 4 nm to about 10 nm, but could be higher or lower depending on the desired application.

In preferred approaches, the magnetic grains 724 (e.g., each of which is comprised of a magnetic grain 720 of the second magnetic recording layer 714 that is positioned directly above a magnetic grain 716 of the first magnetic recording layer 712) have an average aspect ratio (i.e., total thickness, t, to diameter, d) of about 1.2, but could be higher or lower depending on the desired application.

In some approaches, the magnetic grains 716 of the first magnetic recording layer 712 and/or the magnetic grains 720 of the second magnetic recording layer 714 may include chemically ordered L1₀ FePt. In more approaches, the magnetic grains 716 of the first magnetic recording layer 712 and/or the magnetic grains 720 of the second magnetic recording layer 714 may include chemically ordered L1₀ FePtX, where X may include one or more of Ag, Cu, Au, Ni, Mn, Pd, etc. In various approaches, the magnetic grains 716 of the first magnetic recording layer 712 may include one or more materials that are the same or different from the materials comprising the magnetic grains 720 of the second magnetic recording layer 714.

In additional approaches, the first segregant 718 of the first magnetic recording layer 712 and/or the second segregant 722 of the second magnetic recording layer 714 may include C, SiO₂, TiOₓ, AlN, TaN, W, Ti, TiC, TiN, BC, BN, SiN, SiC, TiO₂, CrOₓ, CrN, AlOₓ, Al₂O₃, MgO, Ta₂O₅, B₂O₃, etc., and combinations thereof. It is important to note that the first segregant 718 may include one or more materials that are the same or different as those comprising the second segregant 722.

According to one particular approach, the first magnetic recording layer 712 may include L1₀ FePt-C (30-50 at %), and the second magnetic recording layer 714 may include L1₀ FePt-SiO₂ or L1₀ FePt-TiO₂. However, one disadvantage associated with using an oxide segregant in at least one of the magnetic recording layers is that said layer may exhibit columnar shaped magnetic grains, as well as poor overall magnetic properties (e.g., Hc<0.1 Tesla) that may be unsuitable for HAMR purposes.

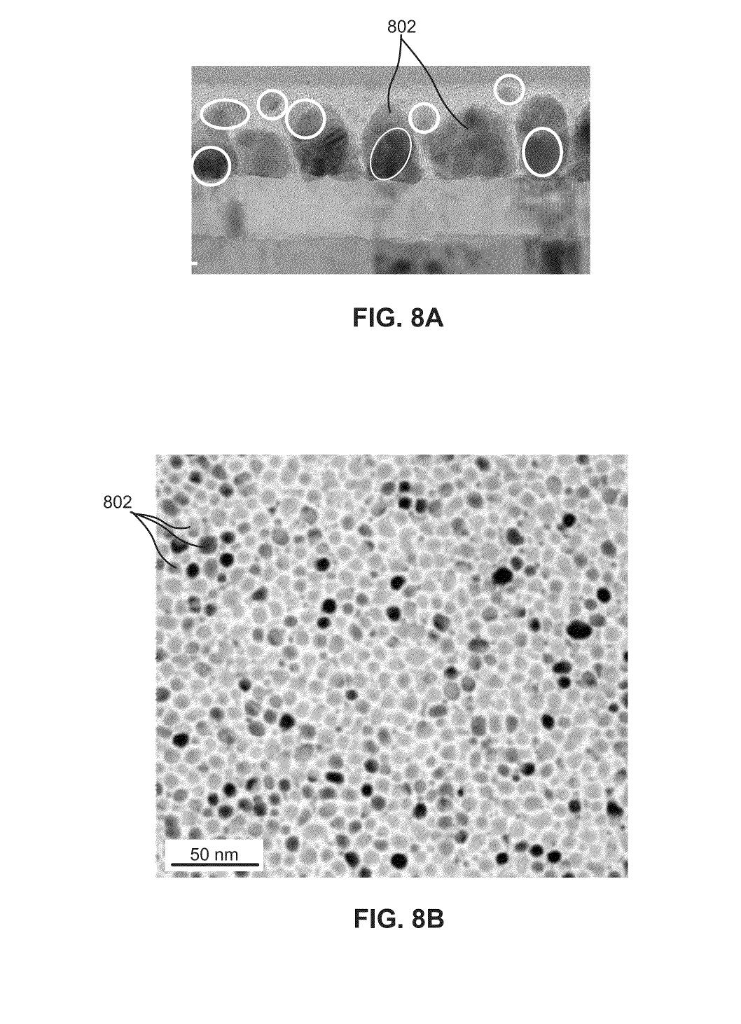

According to another particular approach, both the first and second magnetic recording layers 712, 714 may include L1₀ FePt magnetic grains with a carbon segregant therebetween. In this particular approach, the total amount of segregant in each magnetic recording layer 712, 714 may be in a range from about 10 vol % to about 60 vol %. FIGS. 8A and 8B provide a cross sectional and top down view, respectively, of a TEM image of such a FePt-C/FePt-C magnetic recording bilayer structure. As shown in FIG. 8B, the isolation of each of the FePt magnetic grains 802 by the carbon segregant is desirable. However, while the carbon segregant may achieve a desired degree of magnetic grain isolation, the carbon segregant was nonetheless found to cause the magnetic grains to become rounded, limiting the achievable thickness of the recording layer as a whole. Moreover, additional smaller grains are formed (as noted by the white circles in FIG. 8A), interspersed among the main grain structures 802. The magnetic orientations of these smaller grains may be flipped frequently and oriented randomly, which significantly increases the noise when attempting to read the data stored on the main grain structures.

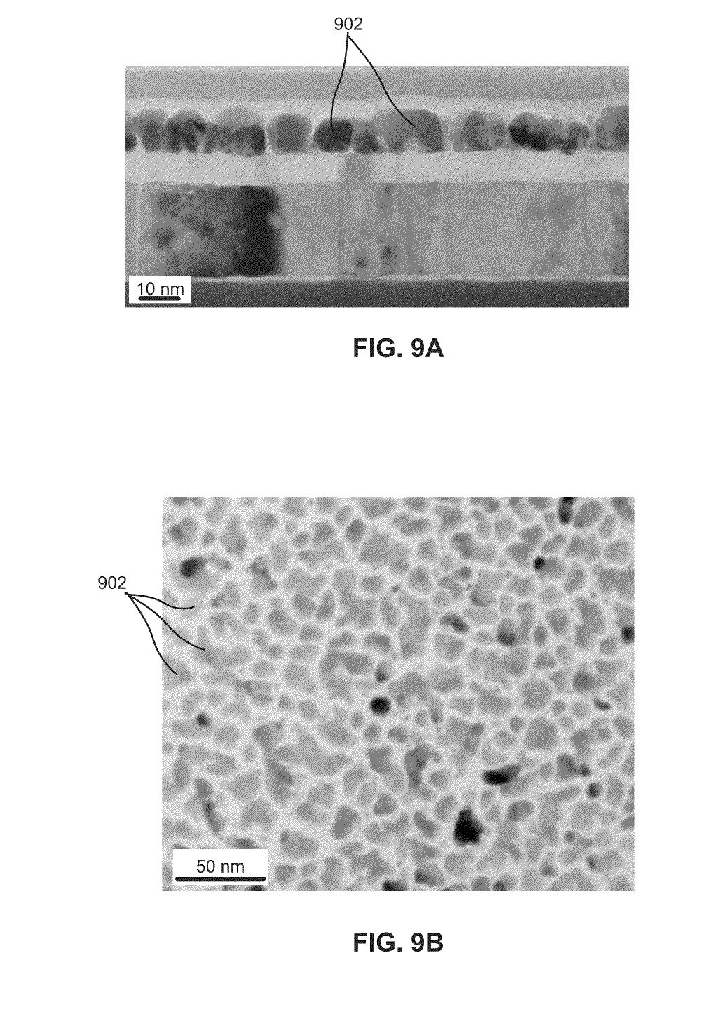

With continued reference to FIG. 7, both the first and second magnetic recording layers 712, 714 may include L1₀ FePt magnetic grains with a carbon and BN segregant therebetween, according to yet another particular approach. In this particular approach, the total amount of segregant in each magnetic recording layer may be in a range from about 10 vol % to about 60 vol %. FIGS. 9A and 9B provide a cross sectional and top down view, respectively, of a TEM image of such a FePt-C +BN/FePt-C+BN magnetic recording bilayer structure. As shown in FIG. 9A, this FePt-C+BN/FePt-C+BN magnetic recording bilayer structure may exhibit fiat interfaces at the tops and bottoms of the magnetic grains 902, however there may also be an undesirable joining between magnetic grains. Joining between magnetic grains may ultimately result in magnetic grains having large diameters, thereby reducing the recording density of the recording layer and causing poor magnetic properties. This joining of the magnetic grains 902 is also apparent in the top down view of a TEM image illustrating this FePt-C+BN/FePt-C+BN magnetic recording bilayer structure shown in FIG. 9B. It is important to note that a FePt-C+X/FePt-C+X magnetic recording bilayer structure, where X may include at least one of SiO₂, TiOₓ, AlN, TaN, W, Ti, TiC, TiN, BC, BN, SiN, SiC, TiO₂CrOₓ, CrN, AlOₓ, Al₂O₃, MgO, Ta₂O₅, B₂O₃, may also exhibit the same or similar characteristics as those associated with the FePt-C+BN/FePt-C+BN magnetic recording bilayer structure shown in FIGS. 9A-9B.

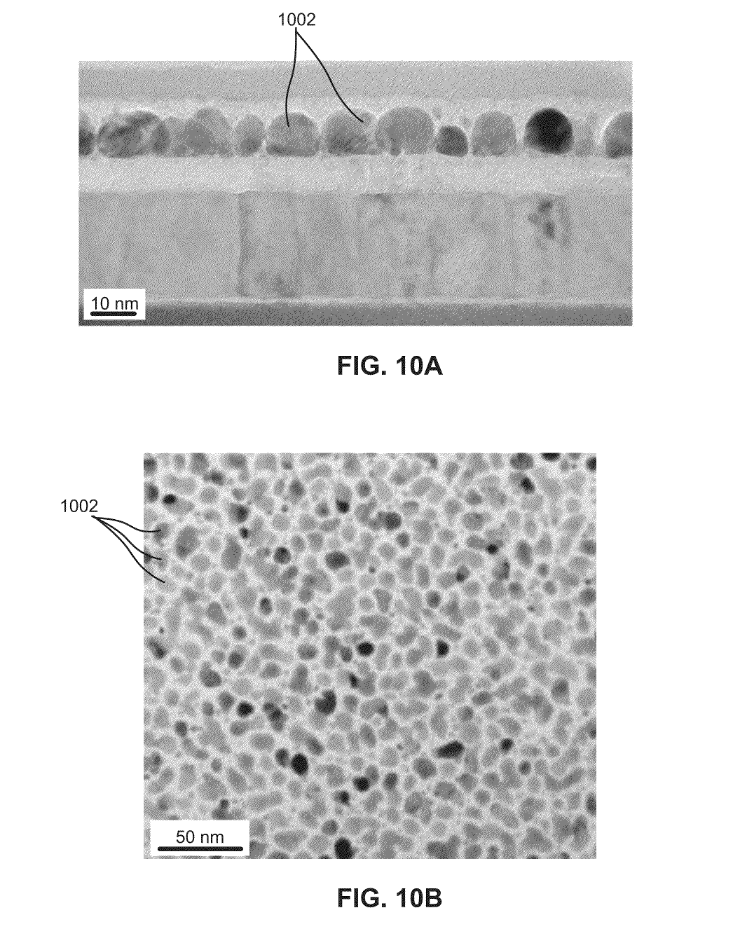

Referring again to FIG. 7, the first magnetic recording layer 712 may include L1₀ FePt magnetic grains with a carbon segregant therebetween, and the second magnetic recording layer 714 may also include L1₀ FePt magnetic grains but with a carbon and a BN segregant (C+BN) therebetween, according to a further approach. In this particular approach, the total amount of segregant in each magnetic recording layer may be in a range from about 1.0 vol % to about 60 vol %. Additionally, regarding the L1₀ FePt-C+BN second magnetic recording layer 714, the carbon segregant may be present in an amount from about 50 at % to 80 at %, and the BN segregant may be present in amount from about 20 at % to about 50 at %. FIGS. 10A and 10B provide a cross sectional and top down view, respectively, of a TEM image of FePt-C+BN/FePt-C magnetic recording bilayer structure with a total thickness, t, of about 10 nm. As illustrated in FIG. 10A, the magnetic grains 1002 in the FePt-C+BN/FePt-C magnetic recording bilayer structure still retain an unwanted spherical shape. Moreover, there is also poor isolation of each of the magnetic grains 1002 in the FePt-C+BN/FePt-C magnetic recording bilayer structure as shown in FIG. 10B. It is important, to note that a FePt-C+X/FePt-C magnetic recording bilayer structure, where X may include at least one of SiO₂, TiOₓ, AlN, TaN, W, Ti, TiC, TiN, BC, BN, SiN, SiC, TiO₂, CrOₓ, CrN, AlOₓ, Al₂O₃, MgO, Ta₂O₅, B₂O₃, may also exhibit the same or similar characteristics as those associated with the FePt-C+BN/FePt-C magnetic recording bilayer structure shown in FIGS. 10A-10B.

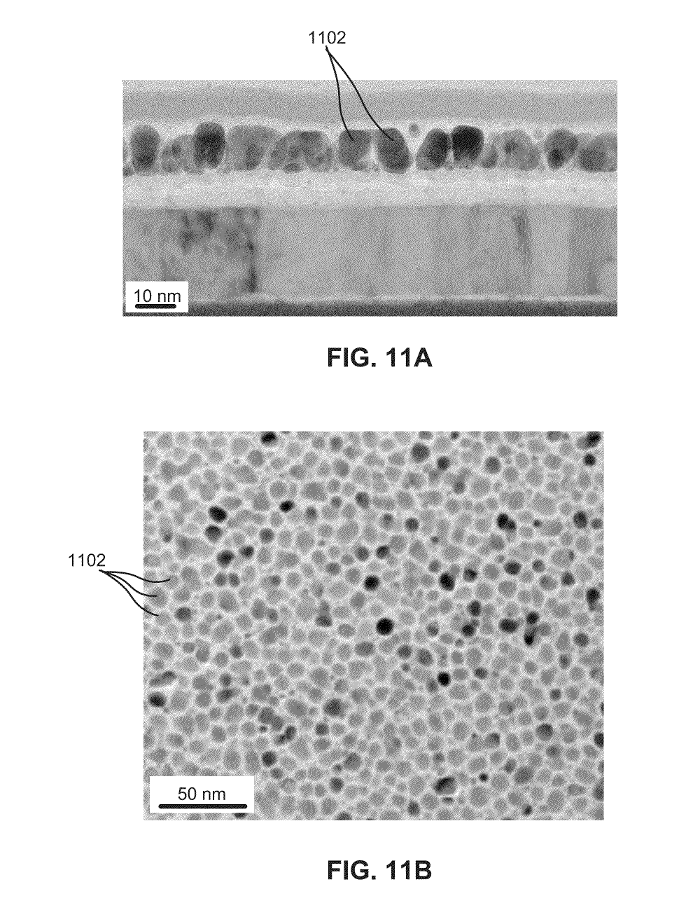

Again with reference to FIG. 7, the first magnetic recording layer 712 may include L1₀ FePt magnetic grains with a carbon and BN segregant (C+BN) therebetween, and the second magnetic recording layer 714 may also include L1₀ FePt magnetic grains but with a carbon segregant therebetween, according to an additional approach. In this particular approach, the total amount of segregant in each magnetic recording layer may be in a range from about 20 vol % to about 40 vol %. Additionally, regarding the L1₀ FePt-C+BN first magnetic recording layer 712, the carbon segregant may be present in an amount from about 50 at % to 80 at %, and the BN segregant may be present in amount from about 20 at % to about 50 at %. FIGS. 11A and 11B provide a cross sectional and top down view, respectively, of a TEM image of FePt-C/FePt-C+BN magnetic recording bilayer structure with a total thickness, t, of about 10 nm. As illustrated in FIG. 11A, the magnetic grains 1102 in the FePt-C/FePt-C+BN magnetic recording bilayer structure have magnetic grains with flat or nearly flat surfaces, e.g., the magnetic grains are more columnar in shape as compared to the FePt-C+BN/FePt-C magnetic recording bilayer structure. Further, FIG. 11B illustrates that there is enhanced magnetic grain 1102 separation in the FePt-C/FePt-C+BN magnetic recording bilayer structure compared to the FePt-C+BN/FePt-C magnetic recording bilayer structure. It is important to note that a FePt-C/FePt-C+X magnetic recording bilayer structure, where X may include at least one of SiO₂, TiOₓ, AlN, TaN, W, Ti, TiC, TiN, BC, BN, SiN, SiC, TiO₂, CrOₓ, CrN, AlOₓ, Al₂O₃, MgO, Ta₂O₅, B₂O₃, may also exhibit the same or similar characteristics as those associated with the FePt-C/FePt-C+BN magnetic recording bilayer structure shown in FIGS. 11A-11B.

As further shown in FIG. 7, the magnetic recording medium 700 includes one or more capping layers 726 present above the magnetic recording bilayer structure 702. The one or more capping layers 726 may be configured to mediate the intergranular coupling of the magnetic grains present in the magnetic recording layer(s). In some approaches, the one or more capping layers 726 may include, for example, a Co—, CoCr—, CoPtCr—, and/or CoPtCrB— based alloy, or other material suitable for use in a capping layer as would be recognized by one having skill in the art upon reading the present disclosure. In more approaches, the one or more capping layers 726 may include continuous magnetic capping layers (i.e., layers without segregant materials included therein), granular magnetic capping layers (i.e. layers with segregants materials included therein), and/or combinations thereof. In approaches where at least one of the one or more capping layers 726 includes a granular magnetic capping layer, any of the segregants disclosed herein may be included in said layer.

While not shown in FIG. 7, the magnetic recording medium 700 may further include a protective overcoat layer positioned above the one or more capping layers 726. The protective overcoat layer may be configured to protect the underlying layers from wear, corrosion, etc. This protective overcoat layer may be made of, for example, diamond-like carbon, carbon nitride, Si-nitride, BN or B4C, etc. or other such materials suitable for a protective overcoat as would be understood by one having skill in the art upon reading the present disclosure. Additionally, the magnetic recording medium 700 may also include an optional lubricant layer positioned above the protective overcoat layer if present. The material of the lubricant layer may include, but is not limited to perfluoropolyether fluorinated alcohol, fluorinated carboxylic acids, etc., or other suitable lubricant material as known in the art.

It is important to note, that while incorporation of a carbon segregant in one of the magnetic recording layers of the magnetic recording bilayer structure 702 of FIG. 7 may improve magnetic grain isolation, and incorporation of a C+BN segregant in the other magnetic recording layer may improve the magnetic grain shape, the magnetic properties of these resulting magnetic recording bilayer structures may still not be sufficient or of a desired degree for HAMR purposes. As such, additional embodiments disclosed below may provide unique magnetic recording multilayer structures that may exhibit reduced surface roughness, avoid rounded magnetic grain shapes at the contact interfaces with additional layers positioned above and/or below, and allow use of a more Voronoi-like type of magnetic grain shape. In particular, the unique magnetic recording multilayer structures described below may form laterally small magnetic grains with flat tops and columnar shapes, and maintain good magnetic properties such as high coercivity values (e.g., above about 3 Tesla). In preferred approaches, these unique magnetic recording multilayer structures may include at least three magnetic recording layers, which may exhibit the required thermal properties for HAMR media.

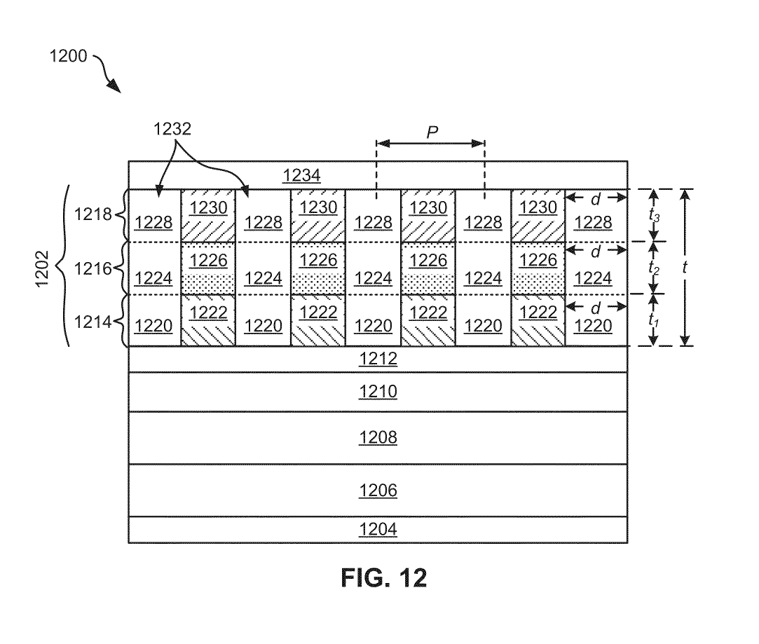

Referring now to FIG. 12, a magnetic recording medium 1200 including a magnetic recording multilayer structure 1202, according to preferred embodiments. As an option, the magnetic recording medium 1200 may be implemented in conjunction with features from any other embodiment listed herein, such as those described with reference to the other Figures. Of course, the magnetic recording medium 1200, and others presented herein may be used in various applications and/or in permutations which may or may not be specifically described in the illustrative embodiments listed herein. For instance, various embodiments of the magnetic recording medium 1200 may include more or less layers than those shown in FIG. 12. Moreover, unless otherwise specified, formation of one or more of the layers shown in FIG. 12 may be achieved via atomic layer deposition (ALD), chemical vapor deposition (CVD), evaporation, e-beam evaporation, ion beam deposition, sputtering, or other deposition technique as would become apparent to a skilled artisan upon reading the present disclosure. Further, the magnetic recording medium 1200 and others presented herein may be used in any desired environment.

As shown in FIG. 12, the magnetic recording medium 1200 includes a substrate layer 1204 comprising a material of high rigidity, such as glass, Al, Al₂O₃, MgO, Si, or other suitable substrate material as would be understood by one having skill in the art upon reading the present disclosure. In preferred approaches, the substrate layer 1204 includes a material that allows media deposition at elevated temperatures, e.g., on the order of 500-800° C.

The magnetic recording medium 1200 also includes an adhesion layer 1206 positioned above the substrate layer 1204. In various approaches, the adhesion layer 1206 may comprise Ni, Ta, Ti, and/or alloys thereof. In preferred approaches, the adhesion layer may comprise an amorphous material that does not affect the crystal orientation of the layers deposited thereon. In some approaches, the thickness of the adhesion layer may be in a range from between about 5 nm to about 300 nm.

The magnetic recording medium 1200 may additionally include an optional heat-dissipating (heat sink) layer 1208 positioned above the adhesion layer 1206. The heat sink layer 1208, which may include a material having a high thermal conductivity (e.g., greater than 30 W/m-K, preferably greater than 100 W/m-K), may be particularly useful for HAMR purposes. In various approaches, this heat sink layer 1208 may be a plasmonic layer. Suitable materials for the heat sink layer 1208 may include, but are not limited to Ta, Ti, Cr, Fe, Cu, Ag, Pt, Au, Cr, Mo, etc. and alloys thereof. In various approaches, the thickness of the heat sink layer 1208 may in a range between about 10 nm to about 100 nm.

The magnetic recording medium 1200 further includes a seed layer 1210 positioned above the heat sink layer 1208. The seed layer 1210 may act as a texture defining layer, e.g., configured to influence the epitaxial growth of the magnetic recording layers 1214, 1216, 1218 formed thereabove. In some approaches, the seed layer 1210 may include MgO, TiN, MgTiOₓ, SrTiOₓ, TiC, etc. or suitable seed layer materials as would become apparent to one skilled in the art upon reading the present disclosure. In more approaches, the seed layer 1210 may have a bilayer structure, e.g., with a lower CrRu layer and an upper Pt layer on the CrRu layer. In particular approaches, the total thickness of the seed layer 1210 may be in a range from about 3 nm to about 10 nm.

The magnetic recording medium 1200 may include an optional onset layer 1212 positioned above the seed layer 1210 and below the magnetic recording multilayer structure 1202, In various approaches, this optional onset layer 1212 may be configured to promote formation of the magnetic recording layers 1214, 1216, 1218 deposited thereabove. In particular approaches, the optional onset layer 1212 may include FePt.

While not shown in FIG. 12, an optional soft magnetic underlayer may be positioned between the adhesion layer 1206 and the seed layer 1210. This soft magnetic underlayer may be configured to promote data recording in the magnetic recording layers 1214, 1216, 1218. Accordingly, in preferred approaches, this soft magnetic underlayer may include a material having a high magnetic permeability. Suitable materials for the soft magnetic underlayer may include, but are not limited to, Fe, FeNi, FeCo, a Fe-based alloy, a FeNi-based alloy, a FeCo-based alloy, Co-based ferromagnetic alloys, and combinations thereof. In some approaches, this soft magnetic underlayer may include a single layer structure or a multilayer structure. For instance, one example of a multilayer soft magnetic underlayer structure may include a coupling layer (e.g., including Ru) sandwiched between one or more soft magnetic underlayers, where the coupling layer is configured to induce an anti-ferromagnetic coupling between one or more soft magnetic underlayers. In some approaches, the soft magnetic underlayer may be a laminated or multilayered soft magnetic underlayer structure including multiple soft magnetic films separated by nonmagnetic films, such as electrically conductive films of Al or CoCr. In more approaches, the soft magnetic underlayer may also be a laminated or multilayered soft magnetic underlayer structure including multiple soft magnetic films separated by inter layer films that mediate an antiferromagnetic coupling, such as Ru, Ir, or Cr or alloys thereof.

It is important to note that in some approaches, the magnetic recording medium 1200 may include the heat sink layer 1208 and a soft magnetic underlayer, both of which may be positioned between the adhesion layer 1206 and the seed layer 1210. In approaches where both a soft magnetic underlayer and a heat sink layer 1208 are present, the soft magnetic underlayer may be positioned above or below the heat sink layer 1208, as equivalent effects may be provided regardless of the position of the soft magnetic underlayer relative to the heat sink layer 1208.

As also shown in FIG. 12, the magnetic recording medium includes the magnetic recording multilayer structure 1202 present above the seed layer 1210. The magnetic recording multilayer structure 1202 includes a first magnetic recording layer 1214, a second magnetic recording layer 1216 positioned above the first magnetic recording layer 1214, and a third magnetic recording layer 1218 positioned above the second magnetic recording layer 1216. The first magnetic recording layer 1214 includes a plurality of magnetic grains 1220 separated by a first segregant 1222. Likewise, the second magnetic recording layer 1216 includes a plurality of magnetic grains 1224 separated by a second segregant 1226. The third magnetic recording layer 1218 also includes a plurality of magnetic grains 1228 separated by a third segregant 1230. In preferred approaches, the plurality of magnetic grains 1220, 1224, 1228 in the first, second and third magnetic recording layers 1214, 1216, 1218 may have a columnar shape.

The magnetic recording layers 1214, 1216, 1218 may be formed using a sputtering process. According to one approach, the magnetic grain material(s) and one or more segregant component(s) may be sputtered from the same target; however, in another approach, the magnetic grain material(s) and/or segregant components) may be sputtered from different, respective targets. The magnetic grain and segregant materials are preferably deposited onto the magnetic recording medium 1200 at the same time, in a heated environment, e.g., from about 400 degrees to about 800° C. in approaches where at least one granular chemically ordered L1₀ FePt magnetic recording layer is desired.

To facilitate a conformal growth of the first, second and third magnetic recording layers 1214, 1216, 1218, an etching step is preferably (but not necessarily) performed on each of the respective magnetic layers after they are formed. Thus, an etching step may be used to define the upper surface of each of the magnetic layers and expose the material of the magnetic layer, e.g., before an additional layer is formed thereabove. According to various approaches, the etching step may include an Inductively Coupled Plasma (ICP) etch step, etc. or any other etching process that would become apparent to one skilled in the art upon reading the present disclosure.

Accordingly, primarily due to the etching step noted above, the magnetic grains 1228 of the third magnetic recording layer 1218 may be physically characterized by growth directly on the magnetic grains 1224 of the second magnetic recording layer 1216, which may in turn be characterized by growth directly on the magnetic grains 1220 of the first magnetic recording layer 1214. Thus, each of the magnetic grains 1220, 1224, 1228 which are formed directly on top of one another may form a larger magnetic grain 1232 that extends along the total thickness, t, of the magnetic recording multilayer structure 1202.

In some approaches, the total thickness, t, of the magnetic recording multilayer structure 1202 may be between about 3 nm to about 20 nm, preferably from about 10 nm to about 15 nm. In more approaches, each of the three magnetic recording layers 1214, 1216, 1218 may have a respective thickness t₁, t₂, t₃, from about 1 nm to about 10 nm. Moreover, the thicknesses t₁, t₂, and t₃ may be the same or different in various approaches.

In numerous approaches, an average pitch, P, (center-to-center spacing) of the magnetic grains 1220, 1224, 1228 in the first, second and/or third magnetic recording layers 1214, 1216, 1218 may be in a range from about 2 nm to about 11 nm, but could be higher or lower depending on the desired application. Furthermore, an average diameter, d, of the magnetic grains 1220, 1224, 1228 in the first, second and/or third magnetic recording layers 1214, 1216, 1218 may preferably be in a range from about 2 nm to about 10 nm, but could be higher or lower depending on the desired application.

In preferred approaches, the magnetic grains 1232 (e.g., each of which is comprised of a magnetic grain 1228 of the third magnetic recording layer 1218 that is positioned directly above a magnetic grain 1224 of the second magnetic recording layer 1216, which is in turn positioned directly above a magnetic grain 1220 of the first magnetic recording layer 1214) have an average aspect ratio (i.e., total thickness, t, to diameter, d) of about 1.5 or larger.

In some approaches, the magnetic grains 1220 of the first magnetic recording layer 1214, the magnetic grains 1224 of the second magnetic recording layer 1216, and/or the magnetic grains 1228 of the third magnetic recording layer 1218 may include chemically ordered L1₀ FePt. In more approaches, the magnetic grains 1220 of the first magnetic recording layer 1214, the magnetic grains 1224 of the second magnetic recording layer 1216, and/or the magnetic grains 1228 of the third magnetic recording layer 1218 may include chemically ordered L1₀ FePtX, where X may include one or more of Ag, Cu, Au, Ni, Mn, Pd, etc. For instance, addition of Ag, preferably in an amount of about 6 at %, may reduce the growth temperature of the layer down to about 870 K. Moreover, addition of Cu, preferably in an amount ranging from about 4 at % to about 8 at %, may reduce the Curie temperature of the layer by about 100 to about 150 K.

In other approaches, the magnetic grains 1220 of the first magnetic recording layer 1214, the magnetic grains 1224 of the second magnetic recording layer 1216, and/or the magnetic grains 1228 of the third magnetic recording layer 1218 may include chemically ordered L1₀ CoPt. In yet more approaches, the magnetic grains 1220 of the first magnetic recording layer 1214, the magnetic grains 1224 of the second magnetic recording layer 1216, and/or the magnetic grains 1228 of the third magnetic recording layer 1218 may include chemically ordered L1₀ CoPtX, where X may include Ag, Cu, Au, Ni, Mn, Pd, etc.

In various approaches, the magnetic grains of at least two of the magnetic recording layers may include one or more materials that are the same or different from one another. For instance, in such approaches, the magnetic grains of at least two of the magnetic recording layers may include the same or different molecular structure, molecular composition, and/or relative amount of components. In more approaches, the molecular structure, molecular composition, and/or relative amount of components in the magnetic grains of all three magnetic recording layers 1214,1216, 1218 may be the same or different.

In additional approaches, the first segregant 1222 of the first magnetic recording layer 1214, the second segregant 1226 of the second magnetic recording layer 1216, and/or the third segregant 1230 of the third magnetic recording layer 1218 may include C, SiO₂, TiOₓ, AlN, TaN, W, Ti, TiC, TiN, BC, BN, SiN, SiC, TiO₂, CrOₓ, CrN, AlOₓ, Al₂O₃, MgO, Ta₂O₅, B₂O₃, etc., and combinations thereof. It is important to note that the molecular structure, molecular composition, and/or relative amount of components in the first segregant 1222, the second segregant 1226 and/or the third segregant 1230 may be the same or different.

In various approaches, the total amount of the first segregant 1222 in the first magnetic recording layer 1214 may be in a range from about 10 vol % to about 60 vol % based on the total volume of the first magnetic recording layer 1214, but may be higher or lower depending on the desired application. Similarly, the total amount of the second segregant 1226 in the second magnetic recording layer 1216 may be in a range from about 10 vol % to about 60 vol % based on the total volume of the second magnetic recording layer 1216, but may be higher or lower depending on the desired application. Additionally, the total amount of the third segregant 1230 in the third magnetic recording layer 1218 may be in a range from about 10 vol % to about 60 vol % based on the total volume of the third magnetic recording layer 1218, but again may be higher or lower depending on the desired application.

In particular approaches, the first segregant 1222 of the first magnetic recording layer 1214 may not primarily include just carbon.

In numerous approaches, the first and third segregants 1222, 1230 of the first and third magnetic recording layers 1214, 1218, respectively, may each be primarily a combination of carbon and a second component, whereas the second segregant 1226 of the second magnetic recording layer 1216 may primarily be carbon. Illustrative materials for the second component of the first and third segregants 1222, 1230 include, but are not limited to, one or more of SiO₂, TiOₓ, AlN, TaN, W, Ti, TiC, TiN, BC, BN, SiN, SiC, TiO₂, CrOₓ, CrN, AlOₓ, Al₂O₃, MgO, Ta₂O₅, B₂O₃, etc.

As used herein, a segregant that is primarily a combination of carbon and a second component may refer to a segregant in which the combined amount of carbon and the second component is about 95 vol % or greater based on the total volume of the segregant. Moreover, in such approaches where a segregant includes carbon and BN, the relative amount of carbon and BN in the segregant may be: C(x at %)+BN(100−x at %); preferably C(50-80 at %)+BN(20-50 at %).

As also used herein, a segregant that is primarily carbon may refer to a segregant in which the total amount of carbon is about 90 vol % or greater based on the total volume of the segregant.

It should also be noted, however, that in some approaches where the first segregant 1222 of the first magnetic recording layer 1214 includes carbon and a second component, the combined amount of carbon and the second component in the first segregant 1222 may be about 50 vol % or more based on the total volume of the first segregant 1222. Similarly, in some approaches where the third segregant 1230 of the third magnetic recording layer 1218 includes carbon and a second component, the combined amount of carbon and the second component in the third segregant 1230 therein may be about 50 vol % or more based on the total volume of the third segregant 1230. Furthermore, in some approaches where the second segregant 1226 of the second magnetic recording layer 1216 includes carbon, the amount of carbon in the second segregant 1226 may be about 50 vol % or more based on the total volume of the second segregant 1226.

According to one particular approach, the first, second and third magnetic recording layers 1214, 1216, 1218 may each include L1₀ FePt magnetic grains (and/or L1₀ FePt-X magnetic grains). However, the first and third segregants 1222, 1230 of the first and third magnetic recording layers 1214, 1218, respectively, may each be primarily a combination of carbon and BN (C+BN), whereas the second segregant 1226 of the second magnetic recording layer 1216 may primarily be carbon. In various approaches the thickness of the FePt-C+BN first magnetic recording layer 1214 may preferably be in a range from about 1 nm to about 3 nm, whereas the thickness of the FePt-C second magnetic recording layer 1216 and the FePt-C+BN third magnetic recording layer 1218 may preferably be in a range from about 1 nm to about 6 nm. This FePt-C+BN/FePt-C/FePt-C+BN magnetic recording trilayer structure may have an overall increased thickness, t, to maximize readback signal, as compared to the single magnetic recording layers with oxide segregants and/or the magnetic recording bilayer structures discussed herein.

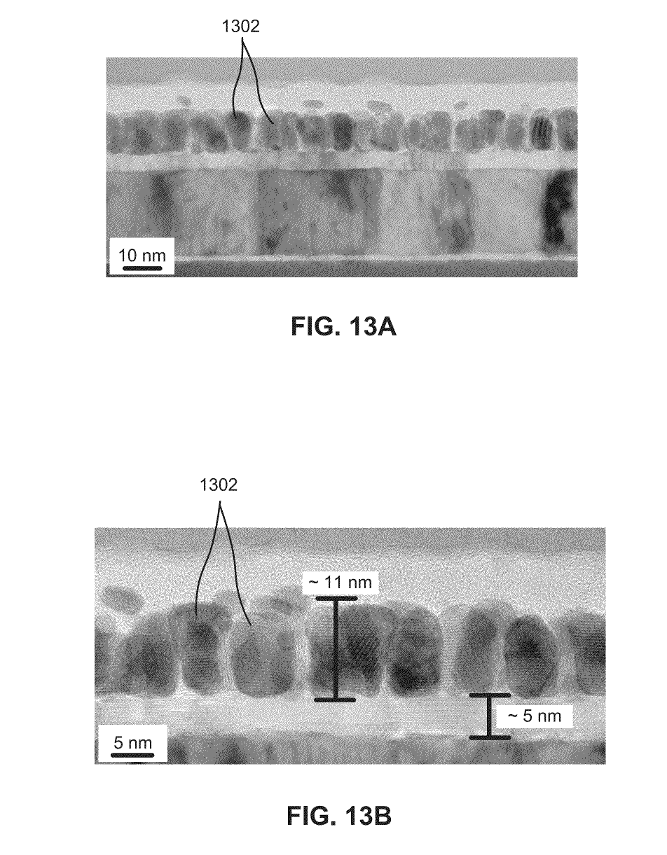

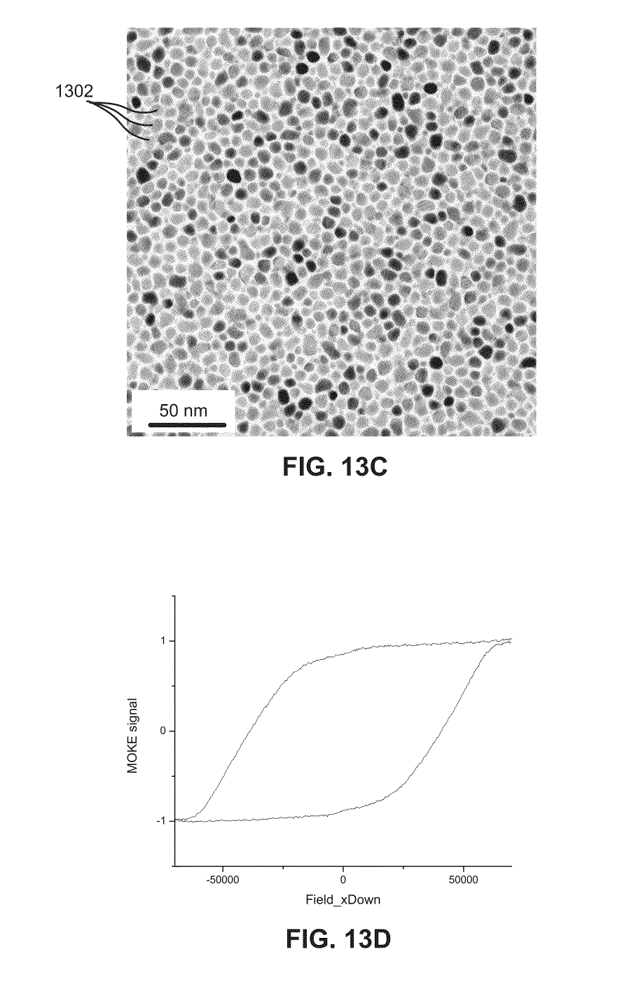

FIG. 13A provides a cross sectional view of a TEM image of a FePt-C+BN/FePt-C/FePt-C+BN magnetic recording trilayer structure, and FIG. 13B provides a close-up view of the TEM image of FIG. 13 A. Moreover, FIG. 13C provides a cross top-down (areal) view of a TEM image of the FePt-C+BN/FePt-C/FePt-C+BN magnetic recording trilayer structure. As illustrated in FIGS. 13A-13B, the FePt-C+BN/FePt-C/FePt-C+BN magnetic recording trilayer structure has laterally small magnetic grains 1302 which have desirable flat top surfaces, columnar shapes, and good thermal contact with at least the seed layer 1210 interface (or the onset layer 1212 layer interface in approaches where the onset layer 1212 is present). Additional, small magnetic grains formed interspersed with the main grain structures may be suppressed by optimizing and/or tuning deposition parameters (such as deposition time, rate, pressure, temperature, etc.), performing an etching process on each of the respective magnetic layers after they are deposited, etc. optimizing the relative atomic percentages of carbon and BN in the first and third magnetic recording layers, etc.

As shown in FIG. 13C, the lateral grain structure of the FePt-C+BN/FePt-C/FePt-C+BN magnetic recording trilayer structure reveals well isolated grains and does not suffer from grain agglomeration or formation of elongated and laterally connected grains as often observed in the single magnetic recording layers with oxide segregants and/or the magnetic recording bilayer structures discussed herein. Moreover, as shown in the hysteresis curve of FIG. 13D, the FePt-C+BN/FePt-C/FePt-C+BN magnetic recording trilayer structure also exhibits desired magnetic properties (e.g., high remanence and high coercivity), which may be particularly useful for HAMR purposes, as compared to the single magnetic recording layers with oxide segregants and/or the magnetic recording bilayer structures discussed herein. It is important to note that a FePt-C+X₁/FePt-C/FePt-C+X₂ magnetic recording trilayer structure, where X₁ and X₂ may each individually include at least one of SiO₂, TiOₓ, AlN, TaN, W, Ti, TiC, TiN, BC, BN, SiN, SiC, TiO₂, CrOₓ, CrN, AlOₓ, Al₂O₃, MgO, Ta₂O₅, B₂O₃, may also exhibit the same or similar characteristics as those associated with the FePt-C+BN/FePt-C/FePt-C+BN magnetic recording trilayer structure shown in FIGS. 13A-13C.

Referring again to FIG. 12, the magnetic recording medium 1200 includes one or more capping layers 1234 present above the magnetic recording multilayer structure 1202. The one or more capping layers 1234 may be configured to mediate the intergranular coupling of the magnetic grains present in the magnetic recording layer(s). In some approaches, the one or more capping layers 1234 may include, for example, a Co—, CoCr—, CoPtCr—, and/or CoPtCrB— based alloy, or other material suitable for use in a capping layer as would be recognized by one having skill in the art upon reading the present disclosure. In more approaches, the one or more capping layers 1234 may include continuous magnetic capping layers (i.e., layers without segregant materials included therein), granular magnetic capping layers (i.e. layers with segregants materials included therein), and/or combinations thereof. In approaches where at least one of the one or more capping layers 1234 includes a granular magnetic capping layer, any of the segregants disclosed herein may be included in said layer.

While not shown in FIG. 12, the magnetic recording medium 1200 may further include a protective overcoat layer positioned above the one or more capping layers 1234. The protective overcoat layer may be configured to protect the underlying layers from wear, corrosion, etc. This protective overcoat layer may be made of, for example, diamond-like carbon, carbon nitride, Si-nitride, BN or B4C, etc, or other such materials suitable for a protective overcoat as would be understood by one having skill in the art upon reading the present disclosure. Additionally, the magnetic recording medium 1200 may also include an optional lubricant layer positioned above the protective overcoat layer if present. The material of the lubricant layer may include, but is not limited to perfluoropolyether, fluorinated alcohol, fluorinated carboxylic acids, etc., or other suitable lubricant material as known in the art.

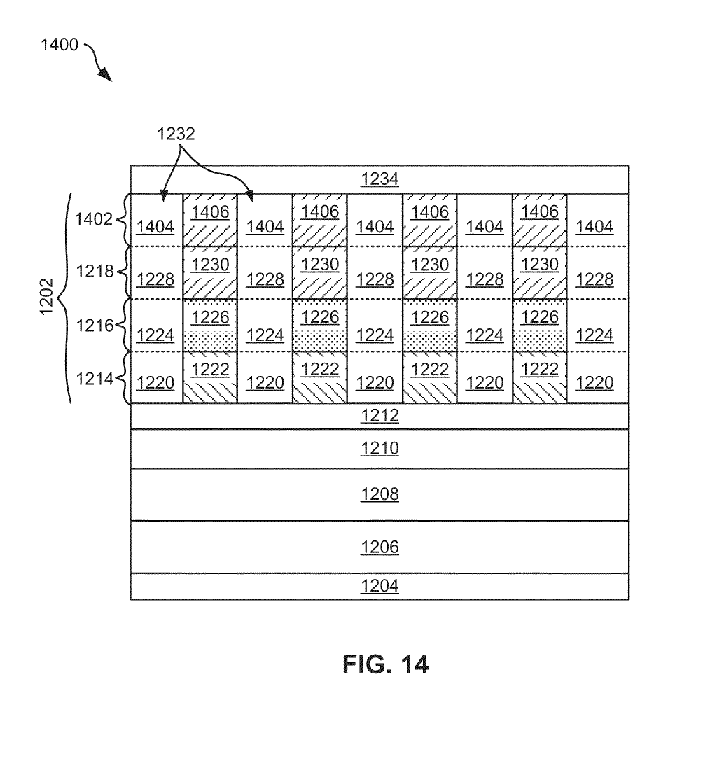

It is important to note that the magnetic recording medium 1200 of FIG. 12 may include more than three magnetic recording layers in various approaches. FIG. 14 provides one such exemplary embodiment of a magnetic recording medium 1400, where said magnetic recording medium includes at least magnetic recording layers. As FIG. 14 depicts one exemplary variation of the magnetic recording medium 1200 of FIG. 12, components of FIG. 14 have common numbering with those of FIG. 12.

As shown in in FIG. 14, the magnetic recording multilayer structure 1202 includes an optional fourth magnetic recording layer 1402 present above the third magnetic recording layer 1218. This fourth magnetic recording layer 1402 may include a plurality of magnetic grains 1404 and a fourth segregant 1406 disposed therebetween in some approaches. The plurality of magnetic grains 1404 for may include any of the materials described herein with reference to the magnetic grains of the first, second and third magnetic recording layers 1214, 1216, 1218. Similarly, the fourth segregant 1406 may include any of the material(s) listed described herein with reference to the segregants of the first, second and third magnetic recording layers 1214, 1216, 1218.

In preferred approaches, the segregant of 1222 of the first magnetic recording layers 1214 and/or the fourth segregant 1406 of the fourth magnetic recording layer may primarily include boron and/or nitrides (particularly BN) combined with carbon. This may be a preferable arrangement in other approaches regardless of the number of magnetic recording layers. For example, in approaches where at least two magnetic recording layers are present, it may be preferable that the segregant of the lower/bottom magnetic recording layer and/or the segregant of the upper/top magnetic recording layer include boron and/or nitrides combined with carbon.

With continued reference to FIG. 14, the first segregant 1222 of the first magnetic recording layer 1214 may not primarily include just carbon in more approaches, which may again be a preferable arrangement regardless of the number of magnetic recording layers.

It is also important to note that the first, second and third magnetic recording layers in the magnetic recording multilayer structure 1202 may each be of high magnetic anisotropy. Accordingly, in various approaches, the optional fourth magnetic recording layer 1402 (as well as other optional, additional magnetic recording layers) may also preferably each be of high magnetic anisotropy, thus helping to retain the high magnetic anisotropy associated with the magnetic grains extending through the magnetic recording multilayer structure.

It should be noted that the results achieved were accomplished by trial and error, and could not have been predicted without conducting the experimentation resulting in structures such as those shown in FIGS. 7-14. Moreover, there was no way for the inventors to predict the results that were observed in each of the different structures. Without washing to be bound by any theory, it is presently believed that for magnetic recording multilayer structures, use of a primarily C+Y based segregant (where Y is a second component such as BN and/or any of the other secondary components disclosed herein) in the top (uppermost) and/or bottom (lowermost) magnetic recording layers promotes a more columnar shape of the magnetic grains and good interfacial contact with additional layers positioned above and/or below the magnetic recording multilayer structure, whereas use of a primarily C-based segregant in at least one middle magnetic recording layer (e.g., a magnetic recording layer positioned between the top and bottom magnetic recording layers) promotes good grain separation.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

It should also be noted that methodology presented herein for at least some of the various embodiments may be implemented, in whole or in part, in computer hardware, software, by hand, using specialty equipment, etc. and combinations thereof.

Moreover, any of the structures and/or steps may be implemented using known materials and/or techniques, as would become apparent to one skilled in the art upon reading the present specification.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A magnetic recording medium, comprising:
a substrate; and
a magnetic recording layer structure positioned above the substrate, the magnetic recording layer structure including:
a first magnetic recording layer having a first plurality of magnetic grains surrounded by a first segregant;
a second magnetic recording layer positioned above the first magnetic recording layer, the second magnetic recording layer having a second plurality of magnetic grains surrounded by a second segregant; and
a third magnetic recording layer positioned above the second magnetic recording layer, the third magnetic recording layer having a third plurality of magnetic grains surrounded by a third segregant,
wherein at least the first segregant is primarily a combination of carbon and a second component,
wherein the second segregant is primarily carbon.

2. The magnetic recording medium as recited in claim 1, wherein the second component is selected from a group consisting of: SiO₂, TiOₓ, AlN, TaN, W, Ti, TiC, TiN, BC, BN, SiN, SiC, TiO₂, CrOₓ, CrN, AlOₓ, Al₂O₃, MgO, Ta₂O₅, B₂O₃, and combinations thereof.

3. The magnetic recording medium as recited in claim 2, wherein the second component is BN.

4. The magnetic recording medium as recited in claim 3, wherein an amount of the carbon present in the first segregant is in a range from about 50 at % to about 80 at %, and wherein an amount of the BN in the first segregant is in a range from about 20 at % to about 50 at %.

5. The magnetic recording medium as recited in claim 2, wherein the third segregant of the third magnetic recording layer is primarily a combination of carbon and the second component.

6. The magnetic recording medium as recited in claim 5, wherein the second component is BN.

7. The magnetic recording medium as recited in claim 1, wherein an amount of the first segregant in the first magnetic recording layer is in a range from about 10 vol % to about 60 vol % based on a total volume of the first magnetic recording layer.

8. The magnetic recording medium as recited in claim 1, wherein an amount of the second segregant in the first magnetic recording layer is in a range from about 10 vol % to about 60 vol % based on a total volume of the second magnetic recording layer.

9. The magnetic recording medium as recited in claim 1, wherein an amount of the third segregant in the third magnetic recording layer is in a range from about 10 vol % to about 60 vol % based on a total volume of the third magnetic recording layer.

10. The magnetic recording medium as recited in claim 1, wherein the magnetic grains of the third magnetic layer are physically characterized by growth directly on the magnetic grains of the second magnetic recording layer, the magnetic grains of the second recording magnetic layer being physically characterized by growth directly on the magnetic grains of the first magnetic recording layer.

11. The magnetic recording medium as recited in claim 1, wherein the magnetic grains of the first, second and third magnetic layers form composite magnetic grains extending through the magnetic recording layer structure, wherein a total thickness of the magnetic recording layer structure is at least 10 nm.

12. The magnetic recording medium as recited in claim 1, wherein the magnetic grains of the first, second and third magnetic layers form composite magnetic grains extending through the magnetic recording layer structure, wherein the composite magnetic grains have an aspect ratio of at least 1.5.

13. The magnetic recording medium as recited in claim 1, wherein an average pitch of the magnetic grains in the first, second and third magnetic recording layers is in a range from about 5 nm to about 11 nm.

14. The magnetic recording medium as recited in claim 1, wherein the magnetic grains of at least one of the first, second and third magnetic recording layers comprise L1₀ FePt.

15. The magnetic recording medium as recited in claim 1, wherein the magnetic grains of at least one of the first, second and third magnetic recording layers comprise L1₀ FePt-X, where X is selected from a group consisting of: Ag, Cu, Au, Ni, Mn, and combinations thereof.

16. The magnetic recording medium as recited in claim 1, wherein the magnetic recording layer structure includes a fourth magnetic recording layer positioned above the third magnetic recording, the fourth magnetic layer including a fourth plurality of magnetic grains surrounded by a fourth segregant.

17. The magnetic recording medium as recited in claim 16, wherein the fourth segregant includes primarily a combination of carbon and the second component.

18. The magnetic recording medium as recited in claim 17, wherein the second component is selected from a group consisting of: SiO₂, TiOₓ, AlN, TaN, W, Ti, TiC, TiN, BC, BN, SiN, SiC, TiO₂, CrOₓ, CrN, AlOₓ, Al₂O₃, MgO, Ta₂O₅, B₂O₃, and combinations thereof.

19. The magnetic recording medium as recited in claim 1, further comprising a seed layer positioned above the substrate and between the magnetic recording layer structure and the substrate, wherein the seed layer includes at least one of: MgO, TiN, MgTiOₓ and SrTiOₓ.

20. A magnetic data storage system, comprising:
at least one magnetic head;
a magnetic recording medium as recited in claim 1;
a drive mechanism for passing the magnetic medium over the at least one magnetic head; and
a controller electrically coupled to the at least one magnetic head for controlling operation of the at least one magnetic head.

21. A magnetic recording medium, comprising:
a substrate; and
a magnetic recording layer structure positioned above the substrate, the magnetic recording layer structure including:
a first magnetic recording layer having a first plurality of magnetic grains surrounded by a first segregant;
a second magnetic recording layer positioned above the first magnetic recording layer, the second magnetic recording layer having a second plurality of magnetic grains surrounded by a second segregant; and
a third magnetic recording layer positioned above the second magnetic recording layer, the third magnetic recording layer having a third plurality of magnetic grains surrounded by a third segregant,
wherein the second segregant is different from the first segregant and/or the third segregant.

22. The magnetic recording medium as recited in claim 21, wherein the second segregant is primarily carbon.

23. The magnetic recording medium as recited in claim 22, wherein the first segregant and/or the third segregant include primarily a combination of carbon and a second component, the second component being individually selected from a group consisting of: SiO₂, TiOₓ, AlN, TaN, W, Ti, TiC, TiN, BC, BN, SiN, SiC, TiO₂, CrOₓ, CrN, AlOₓ, Al₂O₃, MgO, Ta₂O₅, B₂O₃, and combinations thereof.

24. The magnetic recording medium as recited in claim 23, wherein the first segregant and/or the third segregant are each primarily a combination of carbon and the second component, the second component being BN.
